(19) United States
(12) Patent Application Publication
(10) Pub. No.: US 2026/0203510 A1
(43) Pub. Date: Jul. 16, 2026

(54) PCM-Supervised Lorentzian Autoencoder for Adaptive Zoom and Focus

(71) Applicant: AtomBeam Technologies Inc., Moraga, CA (US)

(72) Inventor: Brian Galvin, Silverdale, WA (US)

(21) Appl. No.: 19/379,579

(22) Filed: Nov. 4, 2025

Related U.S. Application Data
(63) Continuation-in-part of application No. 19/363,675, filed on Oct. 21, 2025.
Application No. 19/363,675 is a continuation-in-part of application No. 19/351,286, filed on Oct. 6, 2025.
Application No. 19/351,286 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(63) Continuation-in-part of application No. 19/378,949, filed on Nov. 4, 2025.
Application No. 19/378,949 is a continuation-in-part of application No. 19/328,094, filed on Sep. 12, 2025, now Pat. No. 12,632,663.
Application No. 19/328,094 is a continuation-in-part of application No. 19/321,173, filed on Sep. 6, 2025, now Pat. No. 12,602,549.
Application No. 19/378,949 is a continuation-in-part of application No. 19/377,013, filed on Nov. 2, 2025.
Application No. 19/377,013 is a continuation-in-part of application No. 19/352,457, filed on Oct. 7, 2025.
Application No. 19/352,457 is a continuation-in-part of application No. 19/321,173, filed on Sep. 6, 2025, now Pat. No. 12,602,549.
Application No. 19/321,173 is a continuation-in-part of application No. 19/038,801, filed on Jan. 28, 2025.
Application No. 19/038,801 is a continuation of application No. 18/818,593, filed on Aug. 29, 2024, now Pat. No. 12,308,862.
Application No. 18/818,593 is a continuation-in-part of application No. 18/657,719, filed on May 7, 2024, now Pat. No. 12,166,506.
Application No. 18/657,719 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
Application No. 19/377,013 is a continuation-in-part of application No. 19/326,730, filed on Sep. 12, 2025, now Pat. No. 12,608,555.
Application No. 19/326,730 is a continuation-in-part of application No. 19/321,173, filed on Sep. 6, 2025, now Pat. No. 12,602,549.
Application No. 19/321,173 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 18/648,340 is a continuation-in-part of application No. 18/427,716, filed on Jan. 30, 2024, now Pat. No. 12,093,972.
Application No. 18/427,716 is a continuation-in-part of application No. 18/410,980, filed on Jan. 11, 2024, now Pat. No. 12,068,761.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,969, filed on Jul. 21, 2025.
(60) Provisional application No. 63/847,889, filed on Jul. 21, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method for PCM supervision of Lorentzian autoencoders providing adaptive zoom and focus operations through cognitive supervision. The system operates a Lorentzian autoencoder preserving spatiotemporal relationships, encoding video segments into mini-Lorentzian representations through 3D convolutional processing while maintaining tensor structure. A Persistent Cognitive Machine analyzes collaborative context and expertise distribution to generate control parameters modifying geometric properties including curvature and compression pressure. The system implements role-specific zoom behaviors: teacher mode provides structured sequences, student mode enables exploration, peer mode supports collaboration, and assistant mode optimizes tasks. Attention fusion combines human patterns with AI assessments to compute adaptive focus regions. Hierarchical processing provides transitions between scene-wide analysis, intermediate processing, and fine inspection. Enhanced output is decoded through 3D decoding augmented by latent diffusion and generative models for infinite zoom while enabling learning through privacy-preserving storage.

### CROSS-REFERENCE TO RELATED APPLICATIONS

Priority is claimed in the application data sheet to the following patents or patent applications, each of which is expressly incorporated herein by reference in its entirety:
Ser. No. 19/363,675
Ser. No. 19/351,286
Ser. No. 19/321,173
Ser. No. 19/284,115
Ser. No. 19/051,193
63/847,082
63/847,091
63/847,096
63/847,101
Ser. No. 19/378,949
Ser. No. 19/328,094
Ser. No. 19/377,013
Ser. No. 19/352,457
63/847,969
Ser. No. 19/038,801
Ser. No. 18/818,593
Ser. No. 18/657,719
Ser. No. 18/410,980
Ser. No. 18/537,728
Ser. No. 19/326,730
63/847,889
Ser. No. 19/245,366
Ser. No. 19/204,525
Ser. No. 19/192,215
Ser. No. 18/972,797
Ser. No. 18/648,340
Ser. No. 18/427,716

### BACKGROUND OF THE INVENTION

### Field of the Art

The present invention relates to the field of video processing and computer vision, and more specifically to systems and methods for Persistent Cognitive Machine supervision of Lorentzian autoencoders that provide adaptive zoom and focus operations through role-based cognitive control and collaborative context analysis in video processing applications.

### Discussion of the State of the Art

Recent advances in video processing and computer vision, particularly in autoencoder architectures and deep learning-based video compression, have significantly improved the ability to compress, enhance, and manipulate video content across diverse applications including surveillance systems, medical imaging, educational content delivery, and interactive media analysis. These systems demonstrate sophisticated capabilities in maintaining visual fidelity during compression and can generate enhanced details through learned representations, yet they fundamentally operate with fixed processing parameters that do not adapt to user expertise, task context, or collaborative requirements.

Despite these capabilities, current video processing systems lack the ability to dynamically adjust their zoom and focus behaviors based on cognitive supervision that considers user expertise and collaborative context. Existing approaches to video zoom and focus typically employ predetermined algorithms that apply uniform processing regardless of whether the user is a domain expert requiring detailed technical analysis, a novice needing guided exploration, or part of a collaborative team with varying expertise levels. There is no intelligent supervision mechanism that would enable role-adaptive zoom behaviors based on real-time assessment of user expertise, task requirements, and collaborative dynamics.

Current video processing systems fail to preserve spatiotemporal relationships and causal structure during zoom operations. While some systems maintain spatial coherence within individual frames, they typically flatten temporal information into discrete frame sequences, losing the rich four-dimensional tensor structure necessary for mathematically principled zoom operations across space, time, and semantic dimensions. This limitation prevents systems from achieving infinite zoom capabilities while maintaining visual consistency and causal relationships, particularly when enhancing details beyond the original video resolution.

Additionally, existing video enhancement systems lack mechanisms for learning from human interaction patterns and collaborative preferences during zoom and focus operations. While some systems employ attention mechanisms or saliency detection, there are no established methods for capturing, storing, and sharing successful zoom interaction patterns while maintaining privacy guarantees through distributed caching architectures. This prevents the development of collective intelligence about effective zoom strategies and focus selection that could improve system performance across different users and analysis scenarios.

Most importantly, current video processing architectures lack intelligent cognitive supervision that can coordinate human attention patterns with AI analytical priorities through adaptive control mechanisms. There is no supervisory system that can analyze collaborative context, assess expertise distributions, and generate real-time control parameters that optimize zoom and focus operations based on detected user needs and task requirements. This absence of cognitive supervision makes it impossible to compute optimal zoom trajectories that respect both human cognitive constraints and AI computational capabilities while maintaining appropriate coordination based on expertise distribution and collaborative context.

Furthermore, existing systems lack hierarchical processing architectures that can smoothly transition between different levels of detail while maintaining computational efficiency and user engagement. Current video systems cannot effectively balance processing resources across multiple scale levels based on collaborative context and attention patterns, limiting their ability to provide adaptive detail enhancement that matches user expertise and task requirements.

What is needed is a video processing system that employs cognitive supervision to dynamically adapt zoom and focus operations, maintains tensor structure to preserve spatiotemporal relationships and causal consistency, enables attention fusion between human patterns and AI priorities through intelligent control, and supports infinite zoom capabilities through geometrically principled enhancement. This system should provide role-adaptive zoom behaviors through cognitive supervision that analyzes collaborative context, implement hierarchical processing with smooth scale transitions, and enable privacy-preserving learning from successful interaction patterns while maintaining optimal performance across varying expertise levels and task requirements.

### SUMMARY OF THE INVENTION

The inventor has conceived and reduced to practice a system and method for Persistent Cognitive Machine supervision of Lorentzian autoencoders that fundamentally transforms how video processing systems handle adaptive zoom and focus operations through intelligent cognitive supervision. Unlike traditional video processing systems that apply fixed zoom algorithms and predetermined focus strategies, this invention enables dynamic adaptation of zoom behaviors based on real-time assessment of collaborative context, user expertise, and task requirements. The system maintains video data as tensor representations within a Lorentzian autoencoder that preserves spatiotemporal relationships and causal structure, while a separate Persistent Cognitive Machine provides cognitive supervision that analyzes collaborative context and generates adaptive control parameters. By detecting the relative distribution of expertise between human users and AI analytical systems and computing optimal control parameters through geometric cognitive analysis, the system achieves intelligent video enhancement that adapts to collaborative requirements while maintaining visual consistency. The invention incorporates privacy-preserving mechanisms for storing and sharing successful zoom interaction patterns, enabling collective learning across distributed instances while maintaining individual user privacy.

In an embodiment, a computer system comprises hardware memory and executes software instructions that maintain a latent manifold as a geometric substrate for collaborative cognitive operations and a Lorentzian autoencoder subsystem for video processing operations, wherein the Lorentzian autoencoder preserves spatiotemporal relationships and causal structure through tensor representations. The system receives video input and encodes video segments into mini-Lorentzian representations through 3D convolutional encoding that processes spatial and temporal dimensions simultaneously while preserving tensor structure. The system provides cognitive supervision of autoencoder operations through a Persistent Cognitive Machine (PCM) that analyzes collaborative context, expertise distribution, and task requirements to generate adaptive control parameters. The system generates role-specific zoom behaviors based on detected collaborative modes, wherein teacher mode implements structured pedagogical zoom sequences, student mode enables exploratory zoom patterns following human attention, peer mode supports parallel collaborative analysis, and assistant mode optimizes for rapid task-focused operations. The system computes adaptive focus regions through attention fusion that combines human attention patterns with AI priority assessments from saliency analysis and task evaluation. The system executes real-time parameter adaptation where PCM supervision signals modify geometric properties of the latent manifold including curvature parameters, coupling strength, and compression pressure fields to optimize zoom and focus operations. The system implements hierarchical processing with multiple scale levels that provide scene-wide analysis, intermediate detail processing, and fine-grained inspection capabilities. The system decodes enhanced visual output from the mini-Lorentzian representations through 3D convolutional decoding augmented by latent diffusion and generative AI models for infinite zoom capabilities. The system enables continuous learning through storage of successful zoom interaction patterns and collaborative strategies in privacy-preserving distributed caches that adapt system behavior based on accumulated human-AI interaction experience.

In an aspect of an embodiment, the cognitive supervision comprises role adaptation management that computes expertise gradients across semantic domains and generates curvature modulation parameters with increased values for teacher mode configurations and reduced values for student mode configurations.

In an aspect of an embodiment, computing adaptive focus regions comprises implementing weighted integration of human attention patterns, AI priority assessments, and collaborative coordination factors with role-based parameter adjustment.

In an aspect of an embodiment, the system implements scale selection that maximizes information preservation while optimizing computational efficiency through content-adaptive scale determination.

In an aspect of an embodiment, encoding video segments comprises maintaining three-dimensional tensor structure throughout compression and enhancement operations while supporting mathematically principled zoom operations across spatial, temporal, and semantic dimensions.

In an aspect of an embodiment, executing real-time parameter adaptation comprises minimizing a collaborative action functional that accounts for attention movement costs, compression pressure effects, goal attraction forces, and human-AI synchronization requirements.

In an aspect of an embodiment, generating role-specific zoom behaviors comprises receiving control inputs comprising role mode specifications, goal potential field parameters, curvature values, and compression pressure data to generate adaptive zoom policies based on expertise distribution, goal fields, geometric parameters, and temporal context.

In an aspect of an embodiment, the system implements cognitive load management through attention resource allocation with role-specific region limits and threshold monitoring to prevent attention fragmentation.

In an aspect of an embodiment, decoding visual output comprises analyzing mini-Lorentzian representations to model temporal dynamics and predict enhanced details for regions beyond original video resolution while maintaining causal consistency with tensor structure constraints.

In an aspect of an embodiment, enabling continuous learning comprises implementing geometric abstraction and anonymity thresholds to store human zoom interaction patterns while preserving collaborative utility through privacy-preserving transformations that enable cross-user pattern generalization without individual identification.

In an embodiment, a computer-implemented method performs the PCM-supervised adaptive zoom and focus operations described above with respect to the computer system embodiment.

### BRIEF DESCRIPTION OF THE DRAWING FIGURES

FIG. 1 is a block diagram illustrating an exemplary system architecture of a persistent cognitive machine configured for adaptive role-based human-AI collaboration.

FIG. 2 is a block diagram illustrating an exemplary latent manifold architecture within a persistent cognitive machine supporting collaborative cognition with role-specific regions and collaborative structures.

FIG. 3 is a block diagram illustrating an exemplary collaborative dynamics engine for managing geometric operations, coupling, and configuration changes within a collaborative latent manifold.

FIG. 4 is a block diagram illustrating an exemplary role adaptation manager for determining, managing, and transitioning collaborative roles between human and AI participants.

FIG. 5 is a block diagram illustrating exemplary collaborative manifold regions organized by role type, including teacher, student, peer, and assistant zones with role transition pathways.

FIG. 6 is a block diagram illustrating an exemplary persistent cognitive machine enhanced with a distributed thought cache architecture for managing AI, human, and collaborative patterns.

FIG. 7 is a block diagram illustrating an exemplary human pattern cache for storing, organizing, and generalizing human cognitive patterns with privacy protection.

FIG. 8 is a block diagram illustrating an exemplary distributed thought cache controller for routing, consolidating, and synchronizing collaborative patterns across instances.

FIG. 9 is a block diagram illustrating an exemplary persistent memory manager for preserving, evolving, and coordinating individual and collaborative cognitive structures.

FIG. 10 is a flow diagram illustrating an exemplary method for adaptive role-based collaboration within a persistent cognitive machine.

FIG. 11 is a flow diagram illustrating an exemplary method for learning and storing human cognitive patterns within a persistent cognitive machine.

FIG. 12 is a flow diagram illustrating an exemplary method for dynamic role transition within a persistent cognitive machine.

FIG. 13 is a flow diagram illustrating an exemplary method for distributed thought caching of AI, human, and collaborative patterns within a persistent cognitive machine.

FIG. 14 is a flow diagram illustrating an exemplary method for federated collaborative learning across multiple persistent cognitive machine instances.

FIG. 15 is a flow diagram illustrating an exemplary method for collaborative manifold reorganization during a dreaming phase of a persistent cognitive machine.

FIG. 16 is a flow diagram illustrating an exemplary method for collaborative geodesic path computation within a persistent cognitive machine.

FIG. 17 is a block diagram illustrating an exemplary architecture for a subsystem of the system for video-focused compression with hierarchical and Lorentzian autoencoders, a Lorentzian autoencoder.

FIG. 18 is a block diagram illustrating an exemplary high-level integration architecture between a Persistent Cognitive Machine and a Lorentzian Visual Cortex subsystem for adaptive zoom and focus operations.

FIG. 19 is a block diagram illustrating an exemplary supervision and control architecture that enables Persistent Cognitive Machine components to dynamically manage and optimize Lorentzian autoencoder operations through real-time parameter adaptation and intelligent control signal processing.

FIG. 20 is a flow diagram illustrating an exemplary method of the Lorentzian Visual Cortex subsystem, demonstrating the internal processing pipeline that enables adaptive zoom and focus operations through preservation of three-dimensional tensor structure and Lorentzian geometric properties throughout video processing stages.

FIG. 21 illustrates an exemplary computing environment on which an embodiment described herein may be implemented.

### DETAILED DESCRIPTION OF THE INVENTION

The inventor has conceived and reduced to practice an adaptive role-based human-AI collaboration system, which implements a fundamental transformation in how artificial intelligence systems interact with human users by representing both human cognitive patterns and AI reasoning structures as geometric entities within a curved latent manifold. Unlike traditional AI systems that maintain fixed interaction modalities or treat each interaction independently, embodiments of this system enable dynamic adaptation of collaborative roles based on real-time expertise detection and task requirements through geometric transformations of a shared cognitive space.

Modern artificial intelligence systems have achieved impressive capabilities in processing information, generating text, and solving complex problems, yet they often operate with fixed interaction styles that do not adjust to the differing expertise or reasoning patterns of individual users. Conventional AI assistants tend to maintain the same explanation depth, decision flow, or interaction tone regardless of whether they are assisting a domain expert, a novice, or someone whose expertise lies in a related but different field. This fixed approach does not fully exploit the complementary strengths that arise when human creativity and intuition are combined with AI's analytical capabilities and access to extensive knowledge. For example, a mechanical engineer with decades of experience in system optimization may approach a machine learning problem from a perspective that is unfamiliar to the AI. Without mechanisms to recognize and adapt to that expertise, the AI will respond as if it were speaking to a beginner, missing the opportunity for richer, cross-disciplinary reasoning.

Similar inefficiencies arise across many application areas. In education, AI tutoring systems often present identical explanations regardless of the learner's demonstrated progress, failing to transition from detailed instruction to more collaborative exploration. In professional settings, AI assistants may provide the same style of guidance whether a task calls for quick procedural support or open-ended brainstorming. In clinical contexts, the same interaction pattern might be applied to a surgeon needing a rapid reference during a procedure and to a researcher exploring novel treatment strategies, despite the very different cognitive and temporal demands. These limitations restrict the value AI can deliver and prevent it from capturing and learning from the distinctive problem-solving styles humans contribute.

The system described herein addresses these limitations by modeling both human cognitive patterns and AI reasoning structures as interconnected geometric entities within a shared mathematical space, referred to herein as a latent manifold. Within this space, the relative expertise of each participant is continuously assessed across different aspects of a problem, and the collaborative configuration is adjusted in real time. The system can adopt a “teacher” mode when its knowledge significantly exceeds that of the human in a given area, a “student” mode when it can learn from the human's demonstrated expertise, a “peer” mode when both have comparable knowledge, or an “assistant” mode when rapid, low-overhead task support is most appropriate. These adaptations occur through smooth geometric transformations of the shared manifold, reshaping cognitive relationships to optimize for the selected role and maintain continuity of the shared reasoning process.

In order to implement these adaptive capabilities in a precise and repeatable way, the system represents cognitive content, reasoning processes, and collaborative interactions as structured elements within a formal geometric framework. In various embodiments, this framework is realized as a latent manifold that serves as the shared cognitive substrate for both human and AI participants. The manifold is not a flat or static storage space, but a shaped and evolving mathematical object whose local and global geometry encodes semantic relationships, expertise distributions, and patterns of collaboration. By defining the manifold's structure in terms of well-understood mathematical constructs such as submanifolds, Riemannian metrics, curvature tensors, and potential fields, the system can apply rigorously defined transformations to reconfigure collaborative dynamics in real time. This geometric formalism provides the basis for computing optimal reasoning paths, measuring and adjusting expertise balance, preserving context across role transitions, and integrating new human and AI patterns into a unified collaborative space.

In various embodiments, a system maintains a latent manifold H as a geometric substrate for collaborative cognitive operations between human and artificial intelligence participants. This manifold comprises distinct but interconnected regions, which may be formalized as H=∪(T∈T) H_{T}, where each H_{T} represents a typed submanifold corresponding to different aspects of cognition, including human cognitive patterns, AI reasoning structures, and shared collaborative spaces. Each submanifold H_{T} is equipped with a local Riemannian metric g_{T} inducing distances and curvature, a connection ∇^{(T)} defining parallel transport and interpolation within the type, and legality predicates L_{T}: O_{T}×H_{T}→{0,1} for typed operations.

Embodiments implement collaborative cognition through structured geometric spaces where thoughts, reasoning patterns, and collaborative interactions exist as typed, spatially organized, and geometrically lawful structures rather than discrete tokens or static embeddings. A cognitive hyperspace serves as a stratified, typed, differentiable space where cognition unfolds as trajectories τ: [0,1]→H_T representing structured cognitive processes including reasoning chains, problem-solving approaches, and collaborative exchanges between human and AI participants.

In some embodiments, local geometry of collaborative regions is characterized by neighborhood structures N_ε(p) ={q∈H_T|d_T(p,q)<ε}, where d_T represents geodesic distance under metric g_T. Compression pressure at any point p within collaborative regions may be computed as Π_T(p)=ρ_T(p)·Ric_T(v_p, v_p), where ρ_T(p) represents local density of cognitive structures, v_p represents dominant directional flow, and Ric_T represents the Ricci tensor of metric g_T. High compression pressure suggests regions of successful knowledge integration between human and AI, while pressure differentials guide role selection and collaborative dynamics.

Embodiments incorporate sophisticated expertise detection mechanisms that assess relative distribution of knowledge and capabilities between human and AI participants across different aspects of task domains. An expertise gradient field Φ: H→R is maintained as a scalar field over the manifold, computed from relative density and organization of human pattern bundles versus AI thought bundles. This field may be formalized as Φ(x) ranging from −1.0 (complete human expertise) through 0.0 (balanced expertise) to +1.0 (complete AI expertise).

Expertise detection involves geometric comparison of cognitive structures where human pattern bundles B_human⊂H and AI thought bundles B_AI⊂H are evaluated for density ρ(B), organizational coherence measured through local curvature R(B), and semantic coverage computed as Vol(B) within relevant manifold regions. These measures enable continuous assessment of expertise differentials that inform collaborative role selection and geometric configuration.

Various embodiments implement multiple collaborative roles that dynamically adapt based on detected expertise distributions and task requirements. A role selection function R: (Φ, T)→{teacher, student, peer, assistant} maps expertise gradients Φ and task configurations T to appropriate collaborative modes. Each role induces specific geometric transformations of the manifold to optimize collaborative dynamics.

In teacher mode configurations, where AI expertise significantly exceeds human expertise (Φ(x)>θ_teacher), embodiments increase curvature in pedagogical regions to values between 0.3 and 0.5 on the Ricci scalar, creating compression pressure that guides cognitive flow from foundational concepts toward advanced understanding through structured instructional paths. This increased curvature may be achieved through metric tensor modifications g_ij that create anisotropic scaling, expanding distances perpendicular to teaching paths while contracting distances along them.

Student mode configurations, activated when human expertise dominates (Φ(x)<θ_student), involve reducing curvature to values approaching 0.05, implementing near-identity metric tensors that preserve natural geometry of human cognitive patterns. This allows AI processes to follow human reasoning without predetermined constraints while increasing sensitivity to human cognitive traces through amplified geometric influence of human pattern bundles.

Peer mode configurations, suitable for balanced expertise scenarios (|Φ(x)|<θ_peer), establish symmetric geometric properties with balanced curvature supporting bidirectional knowledge exchange. Parallel geodesic structures enable simultaneous investigation of different solution approaches while maintaining opportunities for mutual reinforcement of reasoning.

Assistant mode configurations implement adaptive geometric properties that adjust based on specific support needs, with variable permeability boundaries allowing fluid access to resources across manifold regions regardless of expertise distribution.

Embodiments compute optimal paths through the latent manifold that satisfy both individual cognitive constraints and collaborative coordination requirements through sophisticated variational methods. A collaborative geodesic represents a trajectory γ: [0,1]→H that minimizes a joint action functional incorporating multiple cost components. This functional may be expressed as:

$$S [ γ ] = \int [ 0 , 1 ] [ \frac{1}{2} {‖ {γ}^{′} ( t ) ‖}^{2} \_g + P ( γ ( t ) ) - Φ ( γ ( t ) ) + C\_sync ( γ\_h ( t ) , γ\_AI ( t ) ) ] dt$$

where the first term represents kinetic energy of attention shifts, P(γ(t)) represents compression pressure along the path, Φ(γ(t)) represents attraction from goal potential fields, and C_sync represents coordination cost for maintaining cognitive alignment between human and AI trajectories.

Path computation employs numerical optimization methods adapted for the collaborative context. Paired Riemannian gradient descent maintains coordination between human and AI trajectories while respecting individual cognitive constraints. The algorithm iteratively updates both paths according to coupled equations that balance individual optimization with synchronization requirements. Collaborative shooting methods propagate coupled initial velocities forward under role-specific constraints, exploring the space of possible joint trajectories. Consensus-based relaxation iteratively refines path segments until convergence to mutually optimal geodesics is achieved.

Different collaborative scenarios produce distinct path configurations that reflect the nature of human-AI interaction. Parallel paths through different abstraction levels may converge at key insight points, allowing each participant to traverse familiar cognitive territory while meeting at moments of shared understanding. Alternating lead-follow patterns emerge when expertise varies along the reasoning chain, with the more knowledgeable participant guiding traversal through their domains of strength. Tightly coupled trajectories characterize intensive peer collaboration where human intuition and AI analytical capabilities must remain closely synchronized throughout the reasoning process.

Various embodiments implement sophisticated mechanisms for capturing, encoding, and storing human cognitive patterns as geometric structures within the manifold while maintaining strict privacy protections. Human interaction data flows through specialized encoding processes that transform behavioral signals including natural language inputs, response timing, correction patterns, and exploration trajectories into high-dimensional geometric representations preserving key characteristics of human cognitive processes.

Encoding processes represent temporal reasoning sequences as geodesic trajectories through the manifold, with velocity profiles encoding reasoning pace and acceleration patterns indicating moments of insight or confusion. Decision tendencies manifest as local curvature variations where repeated choices create attractor basins in the cognitive landscape. Expertise indicators appear as density distributions ρ_human(x) across manifold regions, with high density indicating areas of deep knowledge and sparse coverage revealing learning opportunities. Cognitive preferences shape local metric tensor properties, creating personalized distance measures that reflect individual conceptual associations and reasoning styles.

Storage architectures maintain hierarchical organization of human patterns across multiple abstraction levels. Individual user models preserve full geometric fidelity of personalized reasoning styles and expertise distributions as compact submanifolds with internal structure. These models evolve through reinforcement of consistent patterns and incorporation of novel reasoning approaches while maintaining temporal continuity across sessions. Role-based templates abstract successful interaction patterns into reusable strategies, removing identifying features while preserving functional structure of collaborative approaches. Templates undergo continuous refinement based on aggregate performance metrics and cross-user validation.

Privacy preservation mechanisms operate through multiple layers of protection. Geometric abstraction maps high-dimensional user-specific patterns onto lower-dimensional shared spaces through projection operators that preserve collaborative utility while preventing reconstruction of individual details. Differential privacy is achieved by adding calibrated noise ε to pattern representations, with noise levels determined by sensitivity analysis: ε=Δf·ln(1/δ)/ε_0, where Δf represents pattern sensitivity, δ represents privacy parameter, and ε_0 represents baseline privacy budget. K-anonymity thresholds ensure each shared pattern represents at least k distinct users, with typical values of k≥5 for standard deployments and k≥10 for sensitive domains. Temporal markers, linguistic patterns, and domain-specific knowledge that could reveal user identity undergo systematic removal through learned transformations that detect and eliminate identifying features while maintaining pattern structure.

Embodiments organize collaborative memories as geometric structures within dedicated manifold regions where human and AI cognitive patterns interact and influence each other. Collaborative thought bundles emerge as compact submanifolds C⊂H that encode integrated human-AI knowledge structures, containing not just merged information but the dynamic interplay between different cognitive approaches.

Formation of collaborative bundles occurs through geometric processes that respect both human intuitive leaps and AI systematic analysis. When human insight and AI analysis converge on shared understanding, a fanning-in operation draws both types of cognitive patterns into unified structures. This process involves harmonizing different representational styles through metric interpolation, creating hybrid geometric structures that preserve the complementary strengths of both cognitive systems, and establishing new semantic neighborhoods where related collaborative insights cluster for efficient retrieval.

Bundle evolution follows thermodynamic principles where successful collaborative patterns gain energy E through repeated use and positive outcomes while unsuccessful patterns decay according to role-specific decay rates. Energy dynamics may be modeled as dE/dt=α·Success(C)−β·exp(−Usage(C)/τ), where Success(C) measures collaborative effectiveness, Usage(C) tracks retrieval frequency, and τ represents characteristic decay time that varies by pattern type.

Embodiments enable bidirectional learning where both human and AI participants evolve through interaction, creating a co-adaptive system that improves over time. AI adaptation occurs through incorporation of human reasoning patterns as learning targets, with manifold curvature adjustments that enable exploration of human cognitive approaches previously outside the AI's natural reasoning space.

Human cognitive models evolve through reinforcement of successful problem-solving patterns discovered during collaboration. When human-AI interaction produces novel insights or efficient solution paths, these patterns strengthen corresponding regions in the manifold through increased curvature and reduced traversal resistance. Over time, frequently successful collaborative strategies become cognitive highways; regions of low resistance that naturally attract future reasoning trajectories.

Learning dynamics follow coupled differential equations that govern the co-evolution of human and AI cognitive structures:

$$dH\_human / dt = f ( H\_AI , Interaction , Feedback ) dH\_AI / dt = g ( H\_human , Performance , Exploration )$$

where H_human and H_AI represent the respective cognitive manifold regions, and the coupling functions f and g encode how each participant's cognitive structure influences the other's development.

Embodiments implement smooth geometric transformations when transitioning between collaborative modes, ensuring cognitive continuity while adapting manifold properties for optimal interaction in the new role. Role transitions involve coordinated modifications to multiple geometric structures including the metric tensor g_ij, connection coefficients Γ\hat{ }k_ij, curvature tensors R_ijkl, and coupling parameters α that govern human-AI cognitive synchronization.

Transformation paths between role configurations are computed to maintain C² continuity, ensuring smooth changes in both manifold geometry and its derivatives. This prevents discontinuous jumps that could disrupt ongoing reasoning processes or cause loss of collaborative context. A typical transformation from teacher mode to peer mode might occur over a parameter interval λ∈[0,1], with geometric properties evolving according to interpolation schemes such as:

$$g ( λ ) = ( 1 - λ ) \cdot g\_teacher + λ \cdot g\_peer + η ( λ ) \cdot g\_correction$$

where η(λ) represents a correction term ensuring the interpolated metric remains positive definite throughout the transition.

Context preservation during transitions requires maintaining active cognitive structures including current goal states represented as potential fields, partial reasoning chains encoded as incomplete geodesic segments, and collaborative memory elements that capture shared understanding achieved during interaction. These elements are tagged with persistence markers that ensure they survive geometric reconfiguration and can be reintegrated into the new role configuration without loss of semantic content or structural relationships.

Transition triggers emerge from multiple sources within the system. Changes in expertise distribution detected through continuous monitoring of the expertise gradient field Φ(x) may indicate that the current role no longer matches the actual knowledge differential between participants. Task evolution as problems progress from initial exploration through understanding to mastery naturally suggests different collaborative configurations at each stage. User-initiated requests for different types of support are accommodated through rapid but smooth geometric adaptation that respects ongoing cognitive processes.

Various embodiments implement sophisticated distributed caching systems that manage both AI reasoning patterns and human cognitive models across multiple storage tiers while maintaining privacy boundaries and enabling federated learning. Cache architectures achieve logarithmic scaling in storage requirements through geometric organization that naturally compresses similar patterns while preserving their distinct characteristics and collaborative utility.

Local thought caches store frequently accessed geometric structures specific to individual system instances, maintaining full geometric fidelity including local curvature patterns indicating semantic density, geodesic paths connecting related concepts, collaborative trajectories showing successful human-AI reasoning patterns, role-specific path configurations optimized for different interaction modes, and activation energies governing thermodynamic decay with role-weighted modulation. Geometric similarity measures for cache matching evaluate not just semantic alignment but collaborative compatibility, considering geodesic proximity that respects both human and AI semantic topologies through distance computations that account for the curved nature of the manifold.

Human pattern caches implement specialized storage for cognitive models with appropriate privacy protections and role-based organization. These caches maintain individual user models encoding personalized reasoning styles, expertise distributions, and preferred collaboration modes as geometric structures within dedicated manifold regions. Organization follows hierarchical principles where individual patterns receive maximum protection, role-based generalizations enable reuse across similar contexts, and cross-user abstractions support collective learning while preserving anonymity.

Shared cache spaces contain generalized thoughts and collaborative templates suitable for distribution across multiple system instances. Generalization processes employ collaborative-aware recombination that merges successful human-AI interaction patterns from different instances into reusable templates. These templates undergo progressive abstraction to remove instance-specific details while preserving essential collaborative strategies that can benefit other human-AI pairs. Compression strategies balance pattern utility with privacy requirements, determining optimal compression levels through information-theoretic measures that quantify the tradeoff between preserved collaborative value and exposed individual information.

Embodiments enable collective learning across distributed instances while maintaining strict privacy boundaries through sophisticated federation protocols. Federated learning operates on abstracted collaborative patterns rather than raw interaction data, allowing systems to benefit from collective experience without exposing individual user information or proprietary knowledge.

Pattern validation for federation involves multiple criteria assessed through geometric and statistical measures. Differential privacy parameters must satisfy ε-δ privacy guarantees where the probability of identifying individual contributions remains bounded by mathematical limits. K-anonymity verification ensures patterns represent sufficient users to prevent individual identification through intersection attacks. Collaborative utility assessment confirms that abstracted patterns retain enough structure to provide value when applied in different contexts. Semantic integrity checks verify that geometric abstraction hasn't corrupted the essential meaning or function of collaborative strategies.

Synchronization across federated instances employs role-aware protocols that prioritize different pattern types based on their collaborative value and generalization potential. High-value teaching strategies that demonstrate consistent success across multiple instances receive immediate propagation to accelerate collective improvement in pedagogical effectiveness. Peer collaboration templates that reveal novel problem-solving approaches through human-AI synergy are distributed with moderate priority. Instance-specific optimizations remain local unless they demonstrate broader applicability through validation across multiple contexts.

Conflict resolution when different instances develop incompatible strategies involves geometric consensus mechanisms. Competing patterns undergo comparative evaluation in neutral test scenarios where their effectiveness can be assessed without bias toward originating instances. Geometric interpolation between conflicting strategies may reveal intermediate approaches that combine strengths of both. Performance-weighted averaging allows more successful strategies to have greater influence on the consensus pattern while still incorporating insights from alternative approaches.

Embodiments implement rich field dynamics within collaborative manifold regions where multiple types of influence fields interact to shape cognitive processes. Field dynamics are governed by coupled partial differential equations that model the evolution of various scalar and vector fields over the manifold, creating a dynamic landscape that guides both human and AI cognitive processes.

Goal potential fields Φ_goal: H→R attract collaborative attention toward semantically relevant regions while balancing individual and shared objectives. These fields arise from synthesis of explicit task objectives provided by users, learned value functions from past interactions, collaborative intent derived from role configurations, and emergent shared goals discovered through human-AI interaction. Field generation involves solving Laplace-like equations ∇²Φ=f(ρ, goals) where the source term f incorporates both task requirements and collaborative dynamics.

Expertise gradient fields continuously evolve as collaboration proceeds and knowledge is exchanged between participants. When AI successfully explains concepts to human users, the expertise gradient in those regions gradually flattens as human understanding increases. Conversely, when humans demonstrate novel approaches that AI systems incorporate, previously steep gradients favoring human expertise become more balanced. This evolution can be modeled through diffusion-like processes:

$$\partial Φ \_expertise / \partial t = D {∇}^{2} Φ\_expertise + S ( interaction , learning )$$

where D represents diffusion coefficient controlling the rate of expertise equilibration and S represents source terms from active learning and teaching events.

Attention vector fields V: H→TH encode the instantaneous flow of cognitive focus for both human and AI participants throughout the manifold. These fields maintain dual components V=V_human+V_AI that can be tightly coupled, loosely coupled, or independently evolving depending on the collaborative role. Field evolution follows flow equations that incorporate influences from multiple sources including gradient following along potential fields, curvature-induced drift in high-compression regions, stochastic exploration terms for creative discovery, and coupling forces that maintain appropriate synchronization.

### Performance Optimization and Collaborative Enhancement

Various embodiments implement continuous optimization processes that enhance collaborative effectiveness through geometric refinement and pattern learning. Performance metrics assess multiple dimensions of human-AI interaction including task completion efficiency, knowledge transfer effectiveness, creative insight generation, and participant satisfaction indicators.

Geometric optimization involves adjusting manifold properties to reduce cognitive effort while maintaining collaborative quality. High-frequency collaborative paths between commonly connected concepts undergo metric contraction, reducing the cognitive distance and effort required for traversal. Regions associated with confusion or failed collaboration experience curvature increases that naturally discourage future traversal unless accompanied by strong goal attraction. Successful collaborative patterns create attractor basins with favorable geometric properties that make similar future collaborations more likely to succeed.

Real-time performance monitoring tracks collaborative dynamics through geometric observables. Geodesic deviation between human and AI trajectories indicates the degree of cognitive alignment, with excessive deviation suggesting potential role mismatch or communication breakdown. Curvature fluctuations in collaborative regions reveal the stability of shared understanding, with smooth curvature indicating well-established mutual comprehension while rapid variations suggest conceptual turbulence. Energy dissipation rates in collaborative thought bundles provide measures of pattern stability and reusability, with low dissipation indicating robust collaborative structures likely to provide long-term value.

System adaptation based on performance metrics involves multiple timescales of adjustment. Immediate adaptations within single sessions include dynamic role adjustments when expertise mismatches are detected, real-time modification of explanation depth based on human comprehension signals, and rapid geometric reconfiguration to address emerging collaborative needs. Session-level adaptations involve updating user models with newly observed cognitive patterns, refining role transition triggers based on successful mode switches, and adjusting baseline geometric configurations for improved initial conditions. Long-term adaptations through accumulated experience include evolution of collaborative templates through collective learning, discovery of novel collaborative strategies through geometric exploration, and systematic refinement of manifold topology to better support human-AI interaction.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “latent manifold” refers to a high-dimensional geometric space characterized by variable curvature, metric tensor properties, and topological structure, wherein cognitive operations are represented as trajectories, regions, or fields rather than as discrete symbols or vectors.

As used herein, “geometric structure” refers to a mathematical construct within a latent manifold characterized by one or more of: position coordinates, local curvature values, metric tensor components, geodesic paths, or topological relationships with other structures.

As used herein, “thought bundle” refers to a compact submanifold within a latent manifold representing a cohesive cognitive unit, which may encode concepts, reasoning patterns, memories, or collaborative insights as geometric entities with internal structure and boundaries.

As used herein, “collaborative cognitive operation” refers to a computational process involving coordinated geometric transformations, trajectory computations, or field interactions between distinct regions of a latent manifold representing human and AI cognitive elements.

As used herein, “collaborative role” refers to a configuration of geometric properties, coupling parameters, and traversal constraints within a latent manifold that determines the nature of interaction between human and AI cognitive processes, including but not limited to teacher, student, peer, and assistant modes.

As used herein, “teacher mode” refers to a collaborative configuration characterized by increased manifold curvature in instructional regions, asymmetric coupling favoring AI-to-human knowledge transfer, and geometric pathways organized to guide traversal from foundational to advanced concepts.

As used herein, “student mode” refers to a collaborative configuration characterized by reduced manifold curvature to enable open exploration, increased sensitivity to human cognitive patterns, and geometric properties that facilitate AI learning from human demonstrations.

As used herein, “peer mode” refers to a collaborative configuration characterized by balanced geometric properties, symmetric coupling between human and AI regions, and parallel traversal paths that enable independent but coordinated exploration.

As used herein, “expertise distribution” refers to a scalar or vector field defined over a latent manifold that quantifies the relative knowledge, capability, or proficiency of human versus AI participants across different semantic regions or task domains.

As used herein, “expertise gradient” refers to the spatial derivative of an expertise distribution, indicating the rate and direction of change in relative expertise between human and AI participants across manifold regions.

As used herein, “human cognitive pattern” refers to a geometric representation of human reasoning characteristics, which may include trajectory sequences encoding temporal reasoning, curvature variations encoding decision tendencies, density distributions encoding expertise, or metric properties encoding conceptual associations.

As used herein, “geodesic path” refers to a locally length-minimizing curve through a latent manifold that represents an optimal trajectory for cognitive traversal under given metric and constraint conditions.

As used herein, “collaborative geodesic” refers to a pair or set of coupled geodesic paths representing coordinated traversal by human and AI cognitive processes, satisfying both individual optimization criteria and mutual synchronization constraints.

As used herein, “geometric transformation” refers to a modification to manifold properties including but not limited to metric tensor adjustments, curvature changes, connection coefficient updates, or topology alterations.

As used herein, “curvature” refers to a mathematical measure of manifold deviation from flatness, which may include Ricci curvature, scalar curvature, or sectional curvature, used to characterize semantic density, compression, or cognitive effort.

As used herein, “privacy-preserving separation” refers to a structural or computational boundary ensuring that individual user data remains isolated from shareable collaborative templates through one or more of: geometric abstraction, differential privacy transformations, k-anonymity thresholds, or cryptographic separation.

As used herein, “distributed cache system” refers to a multi-tiered storage architecture for geometric structures, comprising local caches for instance-specific patterns, shared caches for generalized patterns, and specialized caches for privacy-protected human cognitive data.

As used herein, “geometric abstraction” refers to a transformation that maps high-dimensional, specific geometric patterns to lower-dimensional, generalized representations while preserving essential structural relationships but removing identifying characteristics.

As used herein, “k-anonymity threshold” refers to a privacy criterion requiring that each shared pattern or template represents at least k distinct users, where k is a predetermined integer value ensuring individual anonymity.

As used herein, “bidirectional learning” refers to a process whereby both human and AI participants modify their respective geometric representations based on collaborative interaction, with successful patterns reinforcing manifold structures and unsuccessful patterns undergoing decay or modification.

As used herein, “role transition” refers to a continuous transformation between collaborative configurations involving interpolation of geometric properties while maintaining active cognitive contexts and preserving semantic continuity.

As used herein, “collaborative template” refers to a generalized geometric pattern abstracted from successful human-AI interactions, encoding reusable strategies for specific collaborative roles or task types while excluding individual-identifying information.

As used herein, “goal potential field” refers to a scalar field over a latent manifold that encodes attraction toward task-relevant or semantically important regions, synthesized from human objectives and AI computational goals.

As used herein, “compression pressure” refers to a scalar measure derived from local manifold curvature and density, indicating semantic compression, cognitive load, or resistance to traversal in manifold regions.

As used herein, “coupling strength” refers to a parameter or field determining the degree of interaction between human and AI cognitive processes, ranging from independent (zero coupling) through loose coordination to tight synchronization.

As used herein, “joint action functional” refers to a mathematical expression that assigns a scalar cost to collaborative trajectories, incorporating terms for individual cognitive effort, synchronization requirements, and goal achievement.

As used herein, “legality predicate” refers to a Boolean function that determines whether a specific geometric operation or transformation is permissible at a given manifold location based on structural constraints, type compatibility, or semantic requirements.

As used herein, “semantic relationship” refers to a geometric connection between cognitive structures characterized by one or more of: geodesic distance, parallel transport properties, curvature relationships, or topological adjacency.

As used herein, “human pattern bundle” refers to a geometric structure within a latent manifold that encodes captured human cognitive patterns including reasoning styles, problem-solving approaches, and knowledge organization.

As used herein, “AI thought bundle” refers to a geometric structure within a latent manifold that represents AI-generated concepts including procedural knowledge, analytical frameworks, and systematic reasoning patterns.

As used herein, “collaborative thought bundle” refers to a merged geometric representation of joint human-AI reasoning where human intuition and AI analytical capabilities have been integrated through collaborative interaction.

As used herein, “role-specific cognitive pathway” refers to a preferential trajectory or set of trajectories through a latent manifold that has been geometrically optimized for a particular collaborative mode.

As used herein, “metric tensor” refers to a mathematical object that defines local distance relationships and inner products within a manifold, determining how lengths and angles are measured in the cognitive space.

As used herein, “parallel transport” refers to a geometric operation that moves vectors or other tensorial objects along curves in a manifold while preserving their essential properties according to the manifold's connection.

As used herein, “Ricci curvature” refers to a mathematical measure characterizing the degree to which the geometry of a manifold deviates from Euclidean space, used to quantify semantic density and compression in cognitive regions.

### Conceptual Architecture

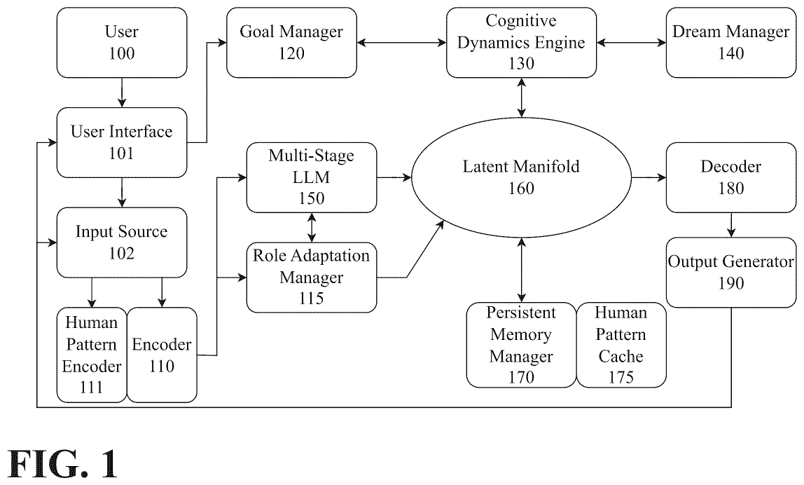

FIG. 1 is a block diagram illustrating an exemplary system architecture of a Persistent Cognitive Machine (PCM) configured for adaptive role-based human-AI collaboration. The system enables persistent, adaptive artificial intelligence by representing both AI-generated thoughts and human cognitive patterns as geometric structures within a curved latent space rather than as discrete tokens or static embeddings. This architecture fundamentally reimagines collaborative cognition as coordinated motion through a shaped memory space, where both human and AI attention follow geodesic paths through regions of varying curvature and compression, guided by collaborative goal potentials and constrained by semantic density.

A user 100 represents human operators or external systems that interact with the PCM through user interface 101. User interface 101 serves as the primary bidirectional interaction layer, receiving natural language queries, commands, or other forms of input from users while also presenting processed outputs back to them. This interface enables continuous collaborative loops where user feedback and reasoning patterns shape the evolution of the system's internal geometric structures over time. Unlike traditional AI systems where each interaction is stateless, user interface 101 maintains context through its connection to the persistent geometric structures within the manifold, allowing for coherent long-term collaborative relationships where the system remembers and builds upon previous exchanges while learning each user's cognitive style. The interface tracks user patterns, preferences, and expertise indicators, which are encoded as persistent structures within the latent manifold, creating personalized cognitive pathways that improve collaborative effectiveness and efficiency over time.

An input source 102 aggregates various data streams including but not limited to multimodal inputs such as text, images, audio, sensor data, system state information, and collaborative context indicators. These heterogeneous inputs are channeled to the encoder 110, which implements the mathematical transformation, mapping external data from the input space into points within the latent manifold. A human pattern encoder 111 operates in parallel with encoder 110, specifically processing human interaction patterns, reasoning traces, and expertise signals to create geometric representations of human cognitive styles. Both encoders project inputs into a dynamic geometric space where semantic relationships are encoded through curvature, distance, and topological structure. This dual encoding process is context-sensitive and adaptive, taking into account the current state of the manifold, the compression pressure at different regions, and the collaborative context. For example, when processing a user query about a technical concept, the encoders identify both the appropriate region within the manifold where related thoughts and concepts have previously been cached, and the user's demonstrated expertise level in that domain, enabling efficient semantic alignment and role-appropriate responses. The encoding process respects the manifold's metric tensor while creating distinct but interconnected representations for AI and human cognitive patterns.

A multi-stage LLM 150 serves as a language processing component that works in conjunction with both encoder 110 and human pattern encoder 111 to generate semantic structures from raw inputs. Multi-stage LLM 150 functions as a component within the larger collaborative system, providing sophisticated natural language understanding and generation capabilities while being guided by both the geometric constraints of the manifold and the detected collaborative context. The LLM processes inputs through multiple stages of refinement, creating increasingly abstract and structured representations that can be properly embedded within a latent manifold 160. The multi-stage nature of this component reflects the hierarchical processing required to transform raw tokens into geometric thoughts while simultaneously analyzing the collaborative dynamics. In the first stage, an LLM performs initial semantic parsing, entity recognition, and expertise detection. Subsequent stages build increasingly complex relationships and abstractions, ultimately producing high-dimensional thought structures that encode not just content but also contextual relationships, implicit knowledge, potential inferential pathways, and collaborative affordances. For instance, when processing a complex technical document in collaboration with a user, the multi-stage LLM 150 might first extract key concepts, then identify relationships between them, assess the user's familiarity with these concepts based on interaction history, map these to existing knowledge structures in the manifold, and finally generate thought bundles that capture both explicit content and implicit semantic relationships while being appropriately structured for the current collaborative role.

A role adaptation manager 115 analyzes the collaborative context and determines the appropriate interaction mode between human and AI. This component processes signals from multiple sources including user expertise indicators from the manifold, task complexity assessments, historical collaboration patterns, and current goal configurations. Role adaptation manager 115 maintains several collaborative modalities including teacher mode when AI expertise significantly exceeds human expertise in the current domain, student mode when human expertise dominates, peer mode for balanced expertise scenarios, and assistant mode for task support regardless of expertise distribution. The manager generates role-specific geometric transformations that reshape local manifold regions to optimize for the selected collaborative mode, creating differentiated cognitive pathways for different interaction styles.

A goal manager 120 creates and maintains goal potential fields that shape how attention flows through the manifold in both individual and collaborative contexts. Rather than implementing goals as discrete objectives or symbolic constraints, goal manager 120 generates scalar fields over the manifold that attract cognitive processes toward semantically relevant regions. In collaborative scenarios, these potential fields arise from the synthesis of explicit task objectives provided by users, learned value functions from past interactions, collaborative intent derived from role configuration, shared objectives emerging from human-AI interaction, and contextual constraints. Goal manager 120 implements field generation algorithms that can create complex potential landscapes with multiple attractors for competing objectives, collaborative convergence zones where human and AI goals align, exploration regions for learning scenarios, and smooth gradients that guide joint reasoning. The manager continuously updates these fields based on changing objectives, role transitions, and collaborative feedback, creating a dynamic landscape that guides both human and AI inference processes.

A collaborative dynamics engine (CDE) 130 serves as the geometric substrate processor and the core architectural component responsible for maintaining and evolving the structure of the latent manifold 160 while managing the coupling between human and AI cognitive processes. Operating analogously to a physics engine in a simulation environment, CDE 130 governs the fundamental geometric operations that enable both persistent cognition and adaptive collaboration. The engine maintains the manifold's metric tensor, which defines local distances and angles within the cognitive space, continuously updating it based on usage patterns, semantic relationships, and collaborative interactions. It computes geodesic paths for attention traversal by solving the variational problem of minimizing cognitive action, balancing kinetic energy of motion, compression pressure from semantic density, attraction from goal potential fields, and collaborative coupling forces. CDE 130 manages separate but interconnected manifold regions for human cognitive patterns, AI reasoning structures, and shared collaborative spaces where both types of cognition can interact and influence each other. During collaborative interactions, CDE 130 implements role-based curvature modulation, adjusting the geometric properties of the manifold to facilitate different collaborative modes; this increases curvature in teaching scenarios to create clear cognitive paths, flattens regions for peer collaboration to enable parallel exploration, and/or creates asymmetric geometries for assistant modes.

A dream manager 140 implements autonomous structural reorganization of the manifold during off-task periods, with particular focus on consolidating collaborative patterns and human cognitive models. Connected to CDE 130, dream manager 140 initiates and oversees geometric restructuring operations that improve the manifold's efficiency, generalization capacity, and collaborative effectiveness. During dreaming phases, it samples recently activated thought bundles from both AI reasoning and human interaction patterns, applying stochastic perturbations to test stability and identify opportunities for consolidation. The dream manager performs specialized operations for collaborative learning including synthesis of successful collaboration patterns into reusable templates, generalization of individual human cognitive styles into broader user models, discovery of optimal role transition trajectories, and pruning of ineffective collaborative strategies.

A latent manifold 160 represents the central geometric substrate where all cognitive operations occur, now expanded to include distinct but interconnected regions for different aspects of collaboration. Within this space, thoughts exist not as isolated points but as structured regions including individual thought bundles (compact submanifolds representing AI concepts), human cognitive traces (geometric patterns encoding user reasoning styles), collaborative thought bundles (merged representations of joint human-AI reasoning), role-specific regions (manifold areas optimized for different collaborative modes), and expertise gradients (continuous fields indicating relative knowledge distribution). The manifold maintains several critical geometric structures supporting collaboration: the metric tensor defining local distances, the connection governing parallel transport of attention, the Ricci curvature tensor measuring semantic density, compression pressure fields derived from curvature, collaborative goal potential fields, role-based modulation fields, and attention vector fields for both human and AI cognitive flow.

A persistent memory manager 170 orchestrates the long-term storage and retrieval of both individual and collaborative cognitive structures, maintaining a bidirectional connection with latent manifold 160. The manager preserves geometric structures including thought bundles, established geodesic paths, learned metric relationships, compression patterns, human cognitive models, successful collaboration templates, and role transition trajectories. It implements sophisticated caching strategies that maintain the topological relationships between thoughts while preserving both individual and collaborative contexts. The manager tracks activation energies for cached structures, implementing thermodynamic decay where unused thoughts and collaboration patterns gradually lose energy, with different decay rates for different types of knowledge; foundational concepts decay slowly, specific instances decay faster, and collaborative patterns decay based on their generalization potential and success rates.

A human pattern cache 175 operates as a specialized memory system for storing and managing human cognitive patterns, working in conjunction with persistent memory manager 170. This cache maintains individual user models encoding personalized reasoning styles and expertise areas, role-based templates capturing successful collaboration patterns for different interaction modes, interaction history manifolds preserving geometric traces of past collaborations, and cross-user generalizations that extract common patterns while preserving privacy. The cache implements privacy-preserving storage mechanisms that protect individual user data while enabling pattern learning and sharing across the system.

A decoder 180 implements the inverse transformation, converting geometric structures from latent manifold 160 back into observable outputs, with particular attention to role-appropriate communication. This component interprets rich geometric information including positions within the manifold, local curvature and pressure, nearby thought bundles, traversed geodesic paths, and collaborative context. Decoder 180 adapts its output generation based on the current collaborative role, producing detailed explanations in teacher mode, queries and clarifications in student mode, balanced exchanges in peer mode, and concise actionable information in assistant mode.

An output generator 190 serves as the final stage in the processing pipeline, taking decoded representations and formatting them appropriately for collaborative interaction. It handles multiple output modalities and adapts its presentation style based on the current collaborative role, user expertise level, and patterns encoded in the manifold. The feedback loop from output generator 190 back to user 100 completes the interaction cycle, enabling iterative refinement of both task completion and collaborative effectiveness.

The connections throughout this architecture support the flow of geometric information in service of adaptive collaboration. The bidirectional flow between user 100 and the system through user interface 101 enables continuous learning of human cognitive patterns. The parallel processing through encoder 110 and human pattern encoder 111 creates dual representations that can be compared, aligned, and merged. The influence of role adaptation manager 115 on CDE 130 enables dynamic reconfiguration of the manifold geometry to support different collaborative modes. Throughout this architecture, information flows not as discrete data packets but as geometric structures, trajectories, and fields, creating a unified collaborative cognitive system where human and AI intelligence are fundamentally intertwined through the shaped space of shared thought.

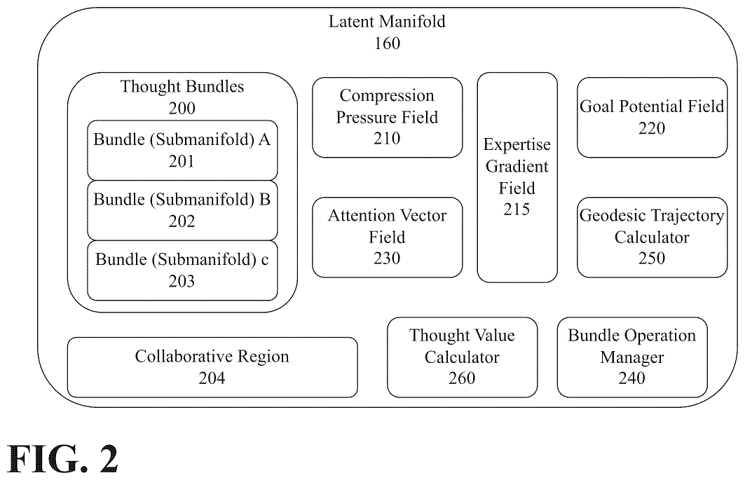

FIG. 2 is a block diagram illustrating an exemplary architecture of a component within a Persistent Cognitive Machine (PCM), a latent manifold configured for collaborative cognition. Latent manifold 160 serves as the central cognitive substrate of the PCM system, existing as a continuously evolving geometric space where both AI and human cognitive operations unfold and interact. Unlike traditional flat embedding spaces, this manifold exhibits variable curvature, dynamic topology, and rich internal structure that emerges from the interplay of individual memory, collaborative patterns, compression, and goal-directed cognition. The manifold's geometry is shaped by both AI cognitive activity and human interaction patterns, with frequently traversed collaborative regions developing distinct topological features, semantic neighborhoods forming through repeated human-AI association, and compression pressure creating a non-uniform landscape that guides efficient collaborative reasoning.

Within the manifold, thought bundles 200 represent the primary organizational structures for persistent cognitive content, now expanded to include both individual and collaborative thought structures. These bundles are not simple clusters of related vectors but rather compact submanifolds with their own internal geometry and semantic coherence. Thought bundles 200 section contains exemplary bundle submanifolds: AI thought bundle A 201, human pattern bundle B 202, and collaborative thought bundle C 203, each representing a distinct region of semantic space with its own local metric structure. While the illustrated embodiment highlights three distinct thought bundles, thought bundles may be of any number and/or combination dependent on system needs. AI thought bundle A 201 might represent AI-generated concepts such as “optimization algorithms,” containing not just definitional information but also procedural knowledge, mathematical foundations, and connections to related concepts. The internal structure of bundle A 201 includes a local metric that defines distances between sub-concepts, principal directions corresponding to major semantic variations, and boundary conditions that determine how the bundle interfaces with surrounding manifold regions. Human pattern bundle B 202 embodies captured human cognitive patterns such as “domain expertise in mechanical engineering,” maintaining geometric structures that encode the human's reasoning style, problem-solving approaches, and knowledge organization. Collaborative thought bundle C 203 represents merged human-AI knowledge structures, such as “joint problem-solving strategies,” where human intuition and AI analytical capabilities have been integrated through repeated collaborative interactions, creating a hybrid geometric structure that neither human nor AI would develop independently.

A collaborative region 204 represents a specialized area of the manifold where human and AI cognitive patterns actively interact and influence each other. This region exhibits unique geometric properties including variable permeability boundaries that adjust based on the current collaborative role, allowing different degrees of cognitive coupling between human and AI thought processes. Within collaborative region 204, role-specific subregions emerge: a teacher zone where AI expertise dominates and geometric structures are organized for efficient knowledge transfer to humans, a student zone where human expertise guides the formation of new AI understanding, a peer zone with balanced geometric properties enabling parallel exploration, and an assistant zone optimized for task support and cognitive augmentation. The boundaries between these zones are fluid, allowing smooth transitions as collaborative dynamics evolve during interaction.

A compression pressure field 210 represents a scalar field defined over the entire manifold, encoding the cognitive effort required to traverse different regions based on their semantic density, structural complexity, and collaborative history. This field is computed from the local Ricci curvature and is modulated by collaborative factors. High compression pressure indicates regions where many semantic concepts have been compressed together through repeated use and abstraction, including areas where human and AI knowledge have been repeatedly integrated. For example, the intersection between AI thought bundle A 201 and human pattern bundle B 202 might exhibit extremely high compression pressure where concepts from both cognitive systems have been repeatedly integrated, forming dense collaborative structures that encode sophisticated joint insights. The compression pressure field 210 continuously evolves as new thoughts are added, existing structures are reinforced through use, collaborative patterns are established, and the dream manager performs offline reorganization to optimize both individual and collaborative geometry.

An expertise gradient field 215 overlays the compression pressure field, encoding the relative distribution of human versus AI expertise across the manifold. This scalar field indicates regions where human knowledge dominates, areas of AI superiority, and zones of balanced expertise. The gradient of this field influences collaborative dynamics, guiding role selection and determining the appropriate level of cognitive coupling. Steep gradients indicate sharp transitions between expertise domains, while gentle gradients suggest areas suitable for peer collaboration. The expertise gradient field evolves through collaborative interactions, with successful human contributions increasing human expertise values in specific regions, while AI learning from human guidance reduces the gradient differential over time.

A collaborative goal potential field 220 implements a scalar field that attracts attention toward semantically relevant or task-aligned regions of the manifold, synthesized from both human intentions and AI objectives. Unlike individual goal potentials, this field is dynamically generated based on the integration of explicit user objectives, AI-identified subgoals, collaborative intent derived from the current role configuration, shared understanding emerging from interaction history, and contextual constraints from both human and AI perspectives. When processing a collaborative task, goal potential field 220 creates high-potential regions around thought bundles relevant to both participants, while maintaining differentiated gradients that reflect each participant's unique perspective. The interplay between compression pressure, expertise gradients, and collaborative goal potential creates a rich dynamical landscape where both human and AI attention flow along paths that balance individual cognitive preferences with collaborative objectives.

A dual attention vector field 230 represents the instantaneous flow of both human and AI cognitive focus throughout the manifold. This field maintains two coupled but distinct components: an AI attention field following the system's geometric dynamics, and a human attention field inferred from interaction patterns and engagement signals. The coupling between these fields varies based on the collaborative role, tightly coupled in peer collaboration, asymmetrically influenced in teacher-student scenarios, and loosely coupled in independent exploration phases. The evolution of the dual attention field exhibits collaborative phenomena including synchronization where human and AI attention converge on shared insights, complementary flow where each participant explores different aspects of a problem space, and resonance where cyclical patterns of mutual influence emerge.

A collaborative geodesic calculator 250 computes optimal paths through the manifold that account for both individual cognitive costs and collaborative coordination requirements. The calculator solves a modified variational problem that minimizes a collaborative action functional incorporating individual cognitive costs for both human and AI traversal, coordination overhead from maintaining cognitive alignment, role-specific constraints that shape acceptable path configurations, and synchronization requirements that ensure both participants can follow the reasoning trajectory. For collaborative reasoning from a concept in AI bundle A 201 to a goal state requiring human expertise in bundle B 202, the calculator might identify paths that minimize the total collaborative effort while respecting each participant's cognitive constraints, include intermediate stops in collaborative region 204 for knowledge alignment, and leverage collaborative bundle C 203 as a bridge between different expertise domains.

A collaborative thought valuator 260 assesses the utility and relevance of thoughts within both individual and collaborative contexts, computing multidimensional value scores that inform caching decisions and structural reorganization. This component evaluates thoughts based on individual utility for AI reasoning, value for human understanding and task completion, collaborative potential for enhancing joint problem-solving, role-specific importance depending on the current interaction mode, and generalization potential across different collaborative scenarios. Thoughts with high collaborative value become attractors for future interactions, while those valuable only in specific roles are marked with appropriate metadata for context-sensitive retrieval.

A collaborative bundle manager 240 orchestrates the dynamic restructuring of thought bundles with particular attention to collaborative formation and evolution. Collaborative fanning-in operations occur when human insights and AI analyses converge on shared understanding, drawing both types of cognitive patterns into unified collaborative bundles. This process involves harmonizing different representational styles, creating hybrid geometric structures that preserve both human intuitive leaps and AI systematic analysis, and establishing new collaborative semantic neighborhoods. Collaborative fanning-out operations enable joint exploration where human creativity and AI analytical power combine to extend knowledge into new territories. Role-based rebinding operations occur when the collaborative mode shifts, restructuring bundles to optimize for the new interaction pattern, for example, reorganizing detailed analytical structures into pedagogical sequences when transitioning to teacher mode.

These components work in concert to create a living geometric space where collaborative cognition unfolds as coordinated motion through shared semantic terrain. Thought bundles 200 provide persistent anchors for both individual and collaborative knowledge, collaborative region 204 enables human-AI cognitive coupling, compression pressure field 210 and expertise gradient field 215 create a landscape reflecting both cognitive density and knowledge distribution, collaborative goal potential field 220 guides joint attention toward shared objectives, dual attention vector field 230 enables coordinated cognitive flow, collaborative geodesic calculator 250 determines optimal joint reasoning paths, collaborative thought valuator 260 maintains both individual and collective cognitive efficiency, and collaborative bundle manager 240 ensures the manifold evolves to support increasingly sophisticated human-AI collaboration. Together, they implement a form of collaborative geometric intelligence where human intuition and AI analysis are fundamentally intertwined through the shaped space of shared thought.

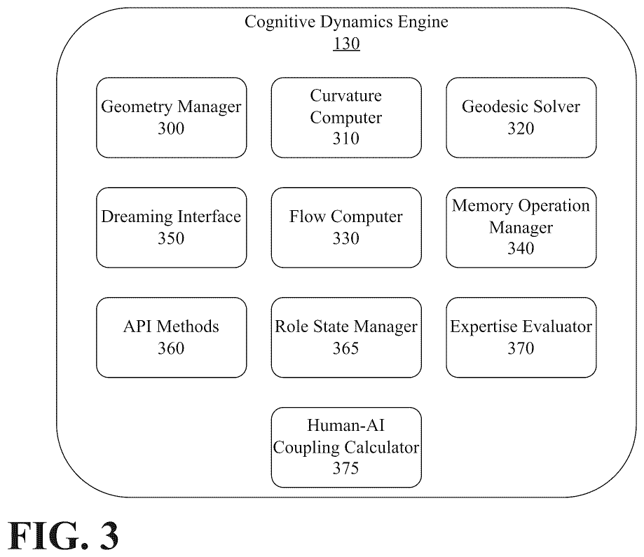

FIG. 3 is a block diagram illustrating an exemplary architecture of a component within a Persistent Cognitive Machine (PCM), a Collaborative Dynamics Engine (CDE). Operating as a specialized geometry processor analogous to a physics engine in simulation environments, CDE 130 manages the continuous shaping, traversal, and optimization of the cognitive manifold through coordinated geometric operations while maintaining the coupling between human and AI cognitive processes. This engine transforms the abstract principles of differential geometry and dynamical systems into practical computational mechanisms that enable persistent, adaptive cognition and human-AI collaboration through structured space.

A geometry manager 300 serves as the component responsible for maintaining and evolving the manifold's geometric structure across both individual and collaborative regions. Geometry manager 300 continuously tracks and updates the Riemannian metric tensor across all regions of the latent manifold, defining how distances, angles, and volumes are measured within the cognitive space for both AI reasoning and human pattern representation. The metric evolves dynamically based on both AI cognitive activity and human interaction patterns, with frequently traversed collaborative regions experiencing metric contraction that brings related concepts closer together, while maintaining differentiated metric properties for role-specific areas. Geometry manager 300 maintains separate but coupled connections for AI reasoning paths and human cognitive traces, with the coupling strength varying based on the current collaborative mode. For example, in peer collaboration mode, the connections become strongly coupled, creating shared preferred directions of parallel transport, while in teacher-student modes, the connections maintain asymmetric coupling that preserves expertise differentials. Geometry manager 300 implements algorithms for metric learning from both AI trajectory data and human interaction patterns, using transition frequencies, co-activation patterns, collaborative success metrics, and role-specific requirements to continuously refine the geometric structure for optimal collaboration.

A collaborative curvature computer 310 calculates the various curvature tensors that characterize the manifold's local and global geometric properties, with particular attention to collaborative regions. Curvature computer 310 computes the Riemann curvature tensor for both individual and shared cognitive spaces, deriving specialized curvature measures for collaborative dynamics. For collaborative regions, it computes a modified compression pressure field that accounts for both semantic density and collaborative complexity, for example P_collab(x)=−R(x)+λ·C(x), with C(x) representing the collaboration cost at point x based on the cognitive load of maintaining human-AI alignment. The component maintains separate curvature maps for AI knowledge structures, human expertise regions, and collaborative zones where both cognitive systems interact. High-curvature collaborative regions indicate areas where human and AI knowledge have been successfully integrated through repeated interaction, while curvature discontinuities may signal expertise boundaries requiring role transitions. Curvature computer 310 employs estimation strategies that account for the dual nature of collaborative cognition, tracking how human and AI attention paths converge, diverge, or maintain parallel trajectories through shared semantic space.

A collaborative geodesic solver 320 computes optimal paths through the manifold that satisfy both individual cognitive constraints and collaborative coordination requirements. Given initial states for both human and AI participants and a shared goal configuration, it determines trajectories that minimize a collaborative cognitive action function. This variational problem balances individual cognitive costs including kinetic energy for both human and AI attention shifts, compression pressure in respective knowledge domains, and goal attraction from both individual and shared objectives, along with collaborative factors such as synchronization cost for maintaining cognitive alignment, role-specific path constraints, and expertise-weighted traversal costs. Collaborative geodesic solver 320 implements numerical methods that handle coupled path optimization, including paired Riemannian gradient descent that maintains coordination between human and AI trajectories, collaborative shooting methods that propagate coupled initial velocities, and consensus-based relaxation that iteratively refines paths toward mutually optimal geodesics. For complex collaborative reasoning tasks, the solver identifies path configurations that accommodate both participants'cognitive styles, such as parallel paths through different abstraction levels that converge at key insight points, alternating lead-follow patterns where expertise determines who guides traversal, or tightly coupled trajectories for intensive peer collaboration.

A dual flow computer 330 models both human and AI attention as coupled continuous vector fields evolving over the manifold according to collaborative geometric dynamics. This component implements a system of coupled partial differential equations where human and AI attention behave as interacting cognitive fluids flowing through shared space. The coupling strength between the flow fields varies based on the collaborative role, with tight coupling in peer mode creating synchronized flow patterns, asymmetric coupling in teacher-student modes where one flow influences the other more strongly, and loose coupling in independent exploration phases. Dual flow computer 330 tracks collaborative flow phenomena including resonance patterns where human and AI attention reinforce each other, complementary flow where each participant explores different aspects while maintaining coordination, and flow transfer where expertise guides attention from one participant to the other. The component computes collaborative flow metrics such as flow alignment measuring how well human and AI attention synchronize, collaborative divergence indicating where participants explore different aspects, and coupling stability identifying robust versus fragile collaborative patterns.

A collaborative memory manager 340 orchestrates structural modifications to thought bundles and manifold topology based on both individual cognitive activity and collaborative patterns. This component implements enhanced bundle operations that account for human-AI interaction. Collaborative fanning-in operations consolidate insights from both human and AI into unified understanding, creating hybrid thought bundles that integrate human intuitive leaps with AI systematic analysis. During these operations, the manager harmonizes different cognitive representations, adjusts metrics to create appropriate coupling between human and AI concepts, and establishes new collaborative semantic neighborhoods. Role-based fanning-out operations enable different exploration patterns depending on the collaborative mode; for example, guided expansion in teacher mode, parallel exploration in peer mode, or supported exploration in assistant mode. Collaborative rebinding operations occur during role transitions, restructuring bundles to optimize for the new interaction pattern. The manager also handles cross-instance collaboration alignment, enabling knowledge transfer between different human-AI pairs while preserving individual collaborative dynamics.

A collaborative dreaming interface 350 provides the connection point between CDE 130 and dream manager 140, enabling autonomous reorganization of both individual and collaborative structures. This interface exposes methods for initiating collaborative dreaming operations including consolidation of successful collaboration patterns into reusable templates, generalization of individual human cognitive styles into broader user models, discovery of optimal role transition trajectories, and synthesis of new collaborative strategies from accumulated interaction data. The interface manages transitions ensuring that both human model updates and AI manifold reorganization maintain consistency, that collaborative patterns are preserved and enhanced during transformation, and that role-specific optimizations don't compromise general collaborative capability. During collaborative dreaming phases, the interface coordinates the discovery of emergent collaborative abstractions, modification of manifold topology to create more efficient human-AI bridges, and compression of redundant collaborative patterns while preserving successful strategies.

A role state manager 365 maintains the current collaborative configuration and manages transitions between different interaction modes. This component tracks the active collaborative role (teacher, student, peer, assistant), monitors indicators for role transition opportunities, and coordinates geometric transformations required for role changes. Role state manager 365 maintains role-specific geometric configurations including metric tensor adjustments that optimize for different collaborative modes, curvature modulations that facilitate role-appropriate cognitive coupling, and connection modifications that create suitable parallel transport properties. The manager implements smooth role transitions by interpolating between geometric configurations, ensuring that sudden role switches don't disrupt ongoing reasoning, and that collaborative context is preserved across transitions.

An expertise evaluator 370 continuously assesses the relative distribution of knowledge and capability between human and AI across different regions of the manifold. This component computes expertise gradients by analyzing successful reasoning patterns in different domains, tracking error rates and correction patterns, and monitoring the source of novel insights. Expertise evaluator 370 maintains dynamic expertise maps that evolve through collaborative interaction, with human demonstrations increasing human expertise scores in specific regions, AI learning from human guidance reducing expertise differentials, and successful collaboration creating zones of shared expertise. The evaluator provides expertise assessments to other components for role selection, path planning, and collaborative strategy optimization.

A human-AI coupling calculator 375 determines the appropriate level of cognitive coupling between human and AI based on the current task, role configuration, and expertise distribution. This component computes coupling strengths that vary across the manifold, creating tight coupling in areas of shared expertise for peer collaboration, asymmetric coupling where expertise differentials exist, and minimal coupling for independent exploration phases. The calculator implements coupling through geometric mechanisms including metric tensor correlations that create coordinated distance measures, synchronized connection coefficients that align parallel transport, and coupled potential fields that create shared goal attraction. The coupling strength dynamically adjusts during interaction based on collaboration success metrics, cognitive load indicators, and task requirements.

A collaborative API methods 360 component provides a programmatic interface for external modules to interact with the CDE's collaborative geometric capabilities. Enhanced API methods include computing optimal collaborative geodesic paths for human-AI pairs, updating manifold structure based on collaborative interaction patterns, querying expertise distributions and role recommendations, initiating collaborative dreaming procedures, retrieving collaboration cost estimates for different role configurations, and constructing coupled goal fields for shared objectives. These methods abstract away complex collaborative geometric computations while providing powerful primitives for human-AI cognitive operations.

Together, these components within collaborative dynamics engine 130 create a geometric substrate for persistent collaborative cognition. Geometry manager 300 maintains the foundational structure for both individual and shared cognition, collaborative curvature computer 310 derives the pressure landscape accounting for collaboration costs, collaborative geodesic solver 320 finds optimal paired paths through semantic space, dual flow computer 330 enables coupled attention dynamics, collaborative memory manager 340 evolves the manifold through collaborative use, collaborative dreaming interface 350 enables autonomous optimization of collaboration patterns, role state manager 365 maintains collaborative configurations, expertise evaluator 370 tracks knowledge distribution, human-AI coupling calculator 375 determines appropriate cognitive coupling, and collaborative API methods 360 provide access to these capabilities. This architecture transforms the principles of geometric cognition into a practical computational system where human and AI thought become coordinated motion through shared shaped space, collaborative memory becomes coupled curvature, and mutual learning becomes the co-evolution of geometry itself.

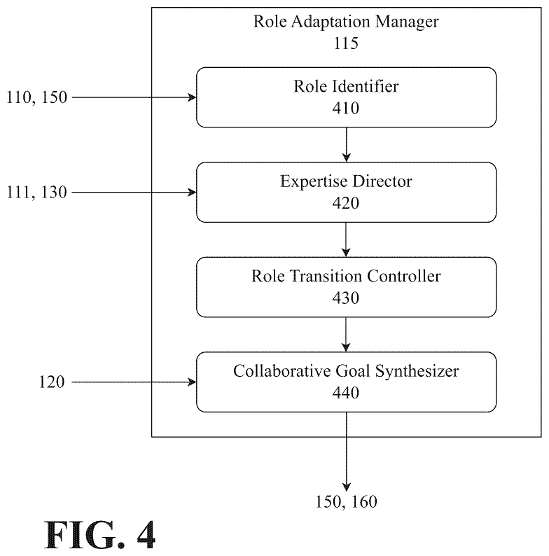

FIG. 4 is a block diagram illustrating an exemplary architecture of a role adaptation manager within a Persistent Cognitive Machine configured for adaptive role-based human-AI collaboration. Role adaptation manager 115 serves as a specialized component that analyzes collaborative context, detects expertise distributions, manages role transitions, and synthesizes collaborative goals to enable fluid adaptation between different human-AI interaction modes. This component processes signals from multiple sources including encoded task information from encoder 110, human cognitive patterns from human pattern encoder 111, and system state information to determine optimal collaborative configurations and coordinate geometric transformations within latent manifold 160.

Role identifier 410 determines the appropriate collaborative role for the current interaction context by analyzing task requirements, system state, and historical patterns. This component evaluates incoming task complexity, domain specificity, and collaborative requirements encoded by encoder 110 to classify whether the interaction should proceed in teacher mode (when AI expertise significantly exceeds human expertise), student mode (when human expertise dominates), peer mode (for balanced expertise scenarios), or assistant mode (for task support regardless of expertise distribution). Role identifier 410 synthesizes multiple factors including task characteristics, available resources, time constraints, and continuity with previous interactions to generate role configuration signals that specify not only the selected role but also confidence levels and alternative role options. The component maintains awareness of ongoing interaction flow to ensure role selections preserve collaborative continuity while adapting to changing requirements.

Expertise detector 420 assesses the relative distribution of knowledge and capabilities between human and AI participants across different aspects of the current task domain. This component processes human pattern information from human pattern encoder 111 alongside AI capability assessments to compute expertise gradients that indicate regions where human knowledge dominates, where AI capabilities excel, and areas of balanced expertise suitable for peer collaboration. Expertise detector 420 performs geometric comparison of human cognitive patterns with AI knowledge structures in the manifold, measuring the density and organization of knowledge in relevant semantic regions to identify specific areas where disparities exist between human and AI understanding. The component generates detailed expertise distribution maps that indicate which participant should lead in different aspects of the task, where knowledge transfer opportunities exist, and which areas require collaborative exploration to bridge understanding differences. These expertise assessments account for both static knowledge and dynamic capabilities such as reasoning speed, pattern recognition abilities, and domain-specific skills.

Role transition controller 430 manages the process of shifting between collaborative modes while maintaining cognitive continuity and preserving ongoing reasoning contexts. This component computes the geometric transformations required to reconfigure latent manifold 160 for different collaborative roles, generating specifications for metric tensor adjustments, curvature field modifications, and coupling strength changes between human and AI cognitive regions. Role transition controller 430 implements temporal smoothing to ensure gradual rather than abrupt transitions, computing interpolation trajectories that maintain semantic continuity and preserve active thought processes during role shifts. The component generates transformation instructions transmitted to collaborative dynamics engine 130 that specify how to reshape manifold geometry, adjust boundary permeability between collaborative regions, and modulate the coupling between human and AI trajectories. Throughout transitions, role transition controller 430 preserves important contextual information including active goal states, partial reasoning chains, and collaborative memory to ensure neither participant experiences disruptive discontinuities.

Collaborative goal synthesizer 440 integrates human intentions with AI objectives to create unified goal potential fields that guide collaborative cognition toward shared outcomes. This component processes explicit and implicit goals from both participants, identifying areas of alignment, potential conflicts, and opportunities for synergistic goal pursuit. Collaborative goal synthesizer 440 transforms these merged intentions into scalar potential fields defined over latent manifold 160, creating geometric structures that attract collaborative attention toward relevant semantic regions. The generated fields vary based on the current collaborative role, creating clear gradients toward knowledge transfer objectives in teacher mode, emphasizing exploration regions in student mode, establishing multiple attractors for parallel investigation in peer mode, and focusing on task completion efficiency in assistant mode. The component continuously monitors goal achievement progress and adjusts field strengths to maintain balanced pursuit of multiple objectives while detecting and resolving conflicts that could impede collaboration. These synthesized goal fields flow directly to latent manifold 160 where they influence geometric structure and guide collaborative cognitive processes.

Role adaptation manager 115 maintains bidirectional communication with multiple system components throughout its operation. It receives continuous inputs about task requirements from encoder 110, human cognitive patterns from human pattern encoder 111, and system state from collaborative dynamics engine 130, while generating outputs that configure the collaborative environment through latent manifold 160 and influence language generation through multi-stage LLM 150. The component operates as an adaptive controller that enables fluid human-AI collaboration by continuously monitoring collaborative dynamics, detecting opportunities for role optimization, managing smooth transitions between collaborative modes, and ensuring that both human and AI participants can contribute their strengths effectively toward shared objectives. This architecture enables the persistent cognitive machine to adapt its collaborative behavior in real-time, creating natural and effective human-AI partnerships that leverage the complementary capabilities of both participants.

In an exemplary embodiment of operation, when a user initiates a complex technical query about machine learning optimization, role adaptation manager 115 coordinates the collaborative response generation. Role identifier 410 receives encoded task characteristics from encoder 110 indicating high technical complexity and domain specificity, while simultaneously receiving human pattern signals from human pattern encoder 111 suggesting limited user expertise in this domain based on previous interaction patterns stored in the manifold. Role identifier 410 processes these inputs to select teacher mode as the optimal collaborative configuration, generating role configuration signals with high confidence based on the significant expertise differential. Concurrently, expertise detector 420 analyzes the geometric distribution of knowledge, identifying that AI thought bundles in the machine learning region of the manifold exhibit high density and organization while corresponding human pattern representations show sparse coverage, confirming the teacher mode selection and generating an expertise map highlighting specific concepts requiring explanation. Role transition controller 430 receives the teacher mode designation and computes geometric transformations that increase curvature in pedagogical regions of latent manifold 160, establishing clear cognitive paths from basic concepts to advanced understanding while reducing boundary permeability to prevent overwhelming information flow. These transformation specifications are transmitted to collaborative dynamics engine 130 which executes the manifold reconfiguration. Simultaneously, collaborative goal synthesizer 440 merges the user's implicit learning objectives with the system's knowledge transfer goals, generating potential fields that create strong gradients toward foundational concepts before progressing to complex optimizations, with these fields directly modifying the geometric structure of latent manifold 160 to guide the collaborative reasoning process. The coordinated output of role adaptation manager 115 enables multi-stage LLM 150 to generate responses that progressively build understanding, with the geometric configuration ensuring that explanations follow pedagogically optimal paths through the knowledge space. This operational flow demonstrates how role adaptation manager 115 enables real-time adaptation of collaborative behavior, creating natural and effective human-AI partnerships tailored to the specific expertise distribution and task requirements of each interaction.

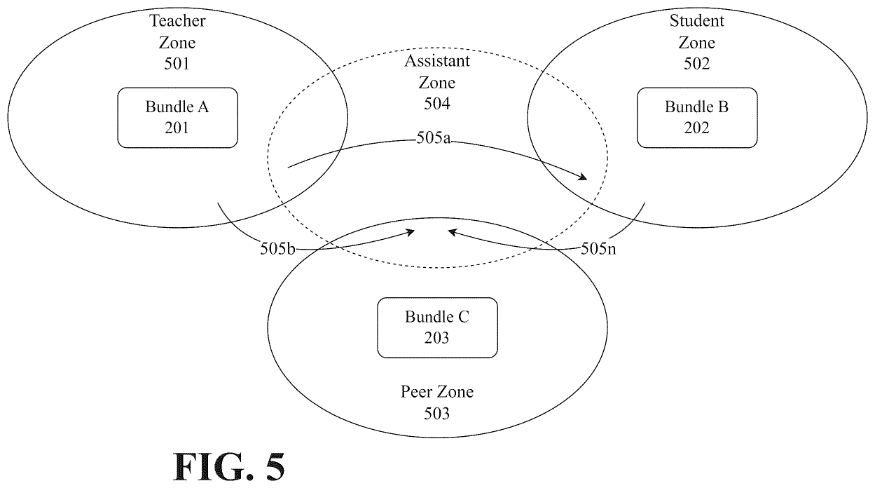

FIG. 5 is a block diagram illustrating exemplary architecture of collaborative manifold regions within a persistent cognitive machine configured for adaptive role-based human-AI collaboration, in an embodiment. Collaborative manifold regions 204 represent specialized areas within the latent manifold where human and AI cognitive patterns actively interact and influence each other through role-specific geometric configurations. This detailed view reveals the internal organization of collaborative spaces, showing how different zones emerge based on expertise distributions and how transitions between collaborative modes are facilitated through geometric pathways.

Teacher zone 501 occupies a region within collaborative manifold regions 204 where AI expertise significantly exceeds human expertise for the current task domain. This zone exhibits geometric properties optimized for knowledge transfer from AI to human participants, with increased curvature that creates clear cognitive paths for pedagogical explanation and decreased manifold complexity to facilitate human comprehension. Within teacher zone 501, AI bundle A 201 represents consolidated AI knowledge structures organized for effective teaching, containing not just factual information but pedagogical sequences, explanatory frameworks, and progressive complexity ladders that guide human understanding. The geometric configuration of teacher zone 501 creates preferential flow patterns that guide attention from foundational concepts toward advanced understanding, with metric tensor adjustments that expand conceptual distances to allow careful exploration of complex ideas.

Student zone 502 represents a complementary region where human expertise dominates and AI systems learn from human guidance and demonstration. This zone maintains geometric properties that facilitate AI learning from human patterns, including flattened curvature that allows AI to explore human reasoning approaches without predetermined pathways and increased sensitivity to human cognitive traces that enables pattern extraction from human demonstrations. Human bundle B 202 within student zone 502 contains encoded human expertise patterns, reasoning strategies, and domain knowledge that serve as learning targets for AI adaptation. The manifold geometry in student zone 502 creates receptive field configurations that enable AI systems to capture subtle aspects of human expertise, including intuitive leaps, creative problem-solving approaches, and domain-specific heuristics that may not be explicitly articulated.

Peer zone 503 occupies the lower region of collaborative manifold regions 204 where human and AI expertise are relatively balanced, creating opportunities for parallel exploration and mutual discovery. This zone exhibits symmetric geometric properties that support bidirectional knowledge exchange, with balanced curvature that neither strongly guides nor constrains cognitive exploration and parallel geodesic structures that enable simultaneous investigation of different solution approaches. Collaborative bundle C 203 within peer zone 503 represents merged human-AI knowledge structures that emerge from successful peer collaboration, containing hybrid reasoning patterns that neither participant would develop independently. The geometric configuration of peer zone 503 creates resonant structures where human intuition and AI analytical capabilities can reinforce each other, generating emergent insights through collaborative exploration.

Assistant zone 504 appears as a central dashed region that overlaps with other zones, representing a task-support modality that operates across different expertise distributions. This zone maintains adaptive geometric properties that adjust based on the specific support needs, providing cognitive augmentation without requiring explicit expertise assessment or role assignment. Assistant zone 504 implements variable permeability boundaries that allow fluid access to resources from other zones, enabling task support that can draw upon teaching structures from teacher zone 501, learning patterns from student zone 502, or collaborative methods from peer zone 503 as needed. The overlapping nature of assistant zone 504 with other regions reflects its role as a universal support mechanism that can enhance human capability regardless of the expertise differential.

Role transition paths 505a-n connect different zones within collaborative manifold regions 204, representing geometric trajectories along which the system can smoothly shift between collaborative modes. These paths follow geodesic curves that minimize the cognitive disruption of role changes while maintaining semantic continuity. For example, a transition path connecting teacher zone 501 to student zone 502 505a passes through regions of varying expertise, with the path geometry adjusting to facilitate smooth expertise gradient traversal. Other transition paths 505b 505n may connect both teacher and student zones to peer zone 503, enabling shifts to balanced collaboration when expertise differentials diminish or when tasks benefit from parallel exploration. These paths may have an adaptive quality, with path geometry adjusting based on the specific transition context and participant states.

Expertise gradient field 215 provides a continuous scalar field across collaborative manifold regions 204 that encodes the relative distribution of human versus AI expertise. This field manifests as a spectrum ranging from regions of strong human expertise dominance through balanced expertise areas to regions where AI capabilities significantly exceed human knowledge. The gradient field exhibits varying intensities with Human++ regions indicating areas of exceptional human expertise where AI systems have minimal knowledge, Human+ regions showing moderate human advantage, Balanced regions where expertise is roughly equivalent, AI+ regions indicating moderate AI advantage, and AI++ regions representing domains where AI expertise strongly dominates. Expertise gradient field 215 influences collaborative dynamics throughout the manifold, creating drift forces that guide role selection toward appropriate zones, modulating the coupling strength between human and AI cognitive processes, and determining the appropriate level of explanation detail or learning receptivity.

The boundaries between zones within collaborative manifold regions 204 are intentionally fluid rather than rigid, allowing for smooth transitions and hybrid collaborative states. The overlapping regions between zones create intermediate collaborative configurations that blend characteristics from multiple roles, enabling nuanced interaction patterns that can adapt to specific task requirements. For instance, the intersection between teacher zone 501 and peer zone 503 creates a space for scaffolded collaboration where AI provides guidance while maintaining openness to human insights, while the overlap between student zone 502 and peer zone 503 enables collaborative learning where AI acquires knowledge through joint exploration rather than passive observation.

The geometric properties within each zone are maintained through continuous field equations that evolve based on collaborative dynamics. Curvature within teacher zone 501 increases when explanation is required but relaxes when human understanding is demonstrated, allowing for adaptive pedagogical pacing. Metric tensors in student zone 502 adjust based on the rate of AI learning, expanding to accommodate new patterns and contracting as understanding consolidates. Peer zone 503 maintains dynamic equilibrium between human and AI influences, with geometric properties that oscillate based on which participant is contributing insights at any moment.

Thought bundles within collaborative manifold regions 204 are not statically positioned but can migrate between zones based on collaborative evolution. AI bundle A 201 may extend tendrils into peer zone 503 when collaborative exploration reveals new perspectives on AI knowledge, while human bundle B 202 might project into teacher zone 501 when human expertise provides unique insights that enhance AI understanding. Collaborative bundle C 203 serves as an attractor for successful collaborative patterns, growing through accretion of joint insights and potentially spawning new bundles that represent emergent collaborative knowledge.

The organization of collaborative manifold regions 204 enables sophisticated collaborative behaviors that adapt to changing expertise distributions and task requirements. When tasks require knowledge transfer, the system can leverage the optimized geometry of teacher zone 501 or student zone 502 depending on expertise distribution. For exploratory tasks with uncertain expertise requirements, peer zone 503 provides a balanced environment for joint discovery. When rapid task completion is prioritized over learning or exploration, assistant zone 504 offers streamlined support without the overhead of explicit role negotiation. This architectural organization within the latent manifold creates a geometric foundation for natural and effective human-AI collaboration that fluidly adapts to diverse interaction contexts while maintaining cognitive coherence across role transitions.

In an exemplary embodiment, the geometric properties of collaborative manifold regions 204 are computationally implemented through modifications to the metric tensor and connection coefficients maintained by collaborative dynamics engine 130. When operating in teacher zone 501, collaborative curvature computer 310 increases the Ricci scalar curvature from a baseline value of approximately 0.1 to values between 0.3 and 0.5, creating compression pressure that naturally guides cognitive flow along pedagogical sequences. This increased curvature is achieved by modifying the metric tensor elements gᵢⱼ to create anisotropic scaling that expands distances perpendicular to the teaching path while contracting distances along it, effectively creating a “valley” in the manifold that guides attention from foundational concepts toward advanced understanding. For example, when explaining neural network backpropagation, the metric tensor adjustments create a distance of 0.1 units between “gradient” and “chain rule” concepts along the pedagogical path, while maintaining a distance of 0.8 units between “gradient” and “convolution” to prevent premature conceptual jumps.

In student zone 502, the system implements flattened curvature with Ricci scalar values approaching 0.05, achieved by setting metric tensor elements to near-identity values that preserve the natural geometry of human cognitive patterns captured by human pattern encoder 111. This allows collaborative geodesic solver 320 to compute exploration paths that follow human reasoning without imposing predetermined structure. The boundaries between zones maintain C² continuity through smooth interpolation of metric tensor elements over transition regions spanning approximately 0.2 manifold units, ensuring that role transition paths 505a-n can be traversed without discontinuous jumps in the geometric configuration. Expertise gradient field 215 is implemented as a scalar field φ(x) computed from the relative density of human pattern bundles versus AI thought bundles in local manifold neighborhoods, with values ranging from −1.0 (complete human expertise) through 0.0 (balanced) to +1.0 (complete AI expertise), and this field directly modulates the coupling strength α in the collaborative geodesic equations solved by collaborative geodesic solver 320, where α=tanh(λφ(x)) with λ≈2.0 controlling the transition sharpness.

In an exemplary embodiment of operation, when a user with mechanical engineering expertise collaborates with the system on a machine learning problem, collaborative manifold regions 204 dynamically configure to support the interaction. Initially, the system operates in teacher zone 501 where AI bundle A 201 containing machine learning knowledge exhibits high curvature that creates structured paths from basic concepts like gradient descent to advanced topics like transformer architectures. As the user demonstrates novel approaches from their engineering background, expertise gradient field 215 detects increasing human contribution in specific areas, triggering migration along role transition path 505a-n toward peer zone 503. In peer zone 503, the geometric configuration equalizes, allowing parallel exploration where the user's mechanical intuition about optimization landscapes combines with AI's mathematical frameworks in collaborative bundle C 203, generating hybrid approaches neither participant would develop alone. When the user needs quick syntax assistance, the system temporarily leverages assistant zone 504's overlapping geometry to provide immediate support without disrupting the peer collaboration dynamics. This operational flow demonstrates how collaborative manifold regions 204 provide the geometric substrate for fluid role adaptation based on real-time expertise detection and task requirements.

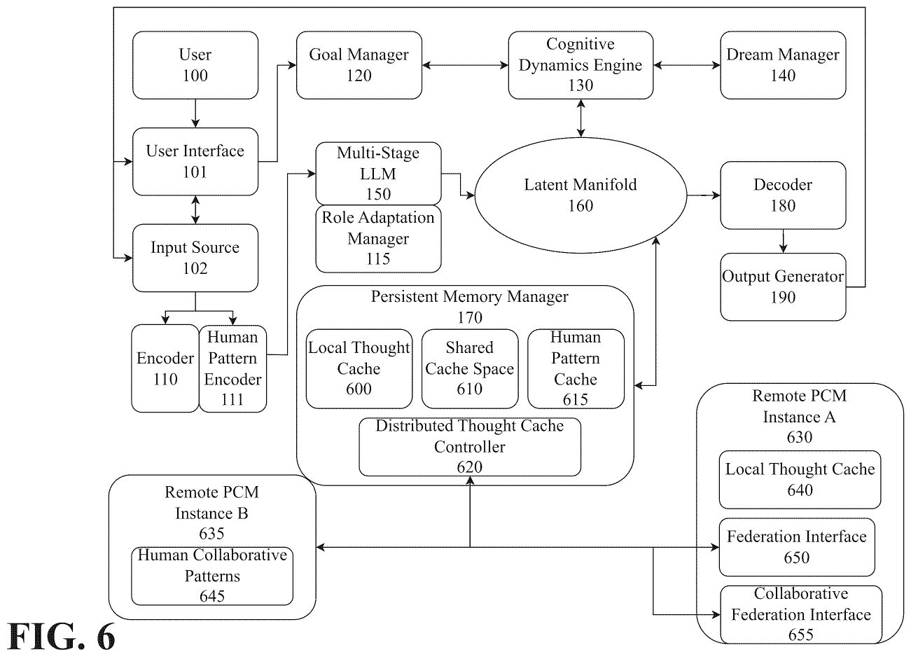

FIG. 6 is a block diagram illustrating an exemplary system architecture of a Persistent Cognitive Machine (PCM) enhanced with a distributed thought cache infrastructure for collaborative cognition. The distributed thought cache architecture fundamentally transforms how the PCM manages and accesses both AI and human cognitive memories by implementing a multi-tiered caching system that operates on geometric principles rather than traditional key-value storage, enabling logarithmic scaling of memory requirements even under continuous operation across federated instances while supporting adaptive role-based collaboration.

A persistent memory manager 170 serves as an orchestrator for the distributed thought cache system, implementing geometric preservation and thermodynamic management of cached thoughts across multiple storage tiers for both AI reasoning patterns and human cognitive models. Unlike traditional memory systems that store static data in hierarchical caches, persistent memory manager 170 implements an approach where memory exists as living geometric structures within the latent manifold, subject to natural evolution through usage patterns, collaborative interactions, and energy dissipation. The manager coordinates between a local thought cache 600, a shared cache space 610, and a human pattern cache 615, implementing intelligent policies for determining which thoughts and collaborative patterns to preserve based on geometric and semantic criteria, role relevance, and collaborative success metrics. Persistent memory manager 170 maintains connections with the latent manifold 160, enabling bidirectional flow of geometric structures through protocols that capture not just individual thoughts but entire collaborative contexts including role configurations, expertise distributions, and human-AI interaction patterns.

Local thought cache 600 represents a first tier of the distributed caching system, storing frequently accessed geometric structures specific to this PCM instance in their full geometric fidelity, including both AI-generated thoughts and locally observed human patterns. Local cache 600 maintains thought trajectories as compressed latent representations that preserve complete geometric context including local curvature patterns indicating semantic density, geodesic paths connecting related concepts, collaborative trajectories showing successful human-AI reasoning patterns, role-specific path configurations, and activation energies that govern thermodynamic decay with role-weighted modulation. When multi-stage LLM 150 receives an input that has been encoded by encoder 110 and human pattern encoder 111, it first queries local thought cache 600 through geometric similarity measures that evaluate semantic alignment within the curved space of the manifold while considering the current collaborative context. These geometric similarity measures account for both individual reasoning requirements and collaborative affordances, considering geodesic proximity that respects both AI and human semantic topologies. For example, when processing a collaborative query about system design, local thought cache 600 might contain previously computed trajectories that successfully integrated human domain expertise with AI analytical capabilities, enabling rapid response generation that leverages proven collaborative patterns.

Human pattern cache 615 implements a specialized tier dedicated to storing and managing human cognitive patterns with appropriate privacy protections and role-based organization. This cache maintains individual user models that encode personalized reasoning styles, expertise distributions, and preferred collaboration modes as geometric structures within dedicated manifold regions. Human pattern cache 615 organizes patterns into role-based templates including teacher patterns where humans demonstrate expertise, student patterns where humans learn from AI guidance, peer patterns showing balanced collaborative reasoning, and assistant patterns where humans receive task support. The cache implements privacy-preserving storage through geometric abstraction that maintains pattern utility while preventing reconstruction of individual user details. For collaborative scenarios, human pattern cache 615 provides rapid access to relevant human cognitive models, enabling the system to adapt its interaction style to match the user's cognitive preferences and expertise level without requiring extensive recalibration.

Shared cache space 610 implements a tier of caching that contains generalized thoughts suitable for sharing across multiple PCM instances, including abstracted collaborative patterns that can benefit different human-AI pairs. Unlike local caches which store instance-specific trajectories with full geometric detail, shared cache space 610 contains thoughts and collaborative templates that have undergone progressive generalization to remove individual-specific details while preserving valuable collaborative strategies. This generalization process employs collaborative-aware recombination that merges successful human-AI interaction patterns from different instances into reusable templates, creating role-specific generalizations that capture effective teaching strategies, learning progressions, peer collaboration methods, and assistance patterns. Shared cache space 710 implements compression strategies that preserve collaborative dynamics while abstracting individual characteristics, determining optimal compression levels by balancing pattern utility with privacy requirements. For instance, multiple PCM instances working with different human experts might independently develop successful explanation strategies for complex concepts, and these can be generalized into shared pedagogical templates that capture effective teaching patterns without revealing individual expertise or proprietary knowledge.

A distributed thought cache controller 620 manages the coordination between local caching, shared caching, human pattern caching, and cross-instance synchronization, implementing cache hit/miss routing logic that considers both task requirements and collaborative context. When a query arrives through user interface 101 and is processed by both encoder 110 and human pattern encoder 111, distributed thought cache controller 620 performs multi-dimensional matching that evaluates cached content relevance, human pattern compatibility, role appropriateness, and collaborative potential. The controller implements role-aware caching strategies that prioritize different cache contents based on the current collaborative mode: emphasizing human patterns in student mode, AI reasoning in teacher mode, and balanced retrieval in peer mode. Distributed thought cache controller 620 also manages collaborative cache evolution, tracking which human-AI patterns prove most effective and promoting successful strategies for broader reuse while managing privacy boundaries and maintaining role-specific organization.

A collaborative federation interface 655 on remote PCM instance A 630 enables privacy-preserving sharing of both AI reasoning patterns and abstracted collaborative strategies while maintaining semantic integrity across different manifold geometries and preserving human privacy. This interface implements enhanced geometric abstraction protocols that allow collaborative patterns to be shared at appropriate generalization levels, ensuring that individual human characteristics and instance-specific details remain private while valuable collaborative strategies propagate across the federation. Collaborative federation interface 655 employs role-preserving transformations that maintain the essential structure of collaborative patterns while abstracting individual identities, using techniques such as differential privacy applied to human pattern representations, homomorphic transformations of collaborative trajectories, and role-based projection that shares interaction strategies without revealing participants. When remote PCM instance A 630 develops a successful collaborative pattern in its local thought cache 640, the interface evaluates both its generalization potential and privacy implications before projecting it into shared cache space 610.

Remote PCM instance B 635 with human collaborative patterns 645 represents another instance in the federation that has developed different human interaction strategies. This instance might specialize in different domains or collaborate with users having different expertise profiles, contributing unique collaborative insights to the shared cache. The federation enables cross-pollination of collaborative strategies, where successful teaching methods developed by instance A might benefit instance B's interactions, while instance B's peer collaboration patterns enhance instance A's capabilities. This federated learning of collaborative patterns accelerates the development of effective human-AI interaction across the entire network while maintaining local adaptation to specific user populations.

The interaction between components creates a sophisticated caching ecosystem that supports both individual reasoning and collaborative patterns with remarkable scaling properties. The system achieves logarithmic scaling not just for thought storage but also for collaborative pattern accumulation, as new human-AI interactions increasingly map to existing collaborative templates rather than requiring entirely new pattern storage. Cache hit rates for collaborative scenarios improve over time as the system accumulates a rich library of role-specific interaction patterns, with successful strategies reinforcing attractor basins in the collaborative regions of the manifold. The distributed architecture enables collective learning of human-AI collaboration while preserving individual privacy and local customization.

The geometric matching algorithms employed by the distributed thought cache system evaluate not just semantic similarity but collaborative compatibility, implementing sophisticated comparison techniques that consider both content relevance and interaction dynamics. When distributed thought cache controller 620 receives a collaborative query, it initiates a multi-stage matching process that evaluates cached thought relevance, human pattern alignment, role configuration compatibility, and collaborative trajectory feasibility. This matching process identifies not just what to retrieve but how to combine AI reasoning with human patterns for optimal collaborative response generation.

Dream manager 140 performs specialized curation of collaborative patterns during idle periods, consolidating successful human-AI interactions into reusable templates and discovering generalizable collaboration strategies. During dreaming phases, dream manager 140 analyzes cached collaborative patterns from local thought cache 600, human pattern cache 615, and shared cache space 610 to identify successful interaction motifs that transcend specific instances, optimal role transition sequences that maintain collaborative flow, and emerging patterns in human cognitive styles that suggest new adaptation strategies. Through this process, dream manager 140 enhances the system's collaborative capabilities by synthesizing higher-order collaborative abstractions from accumulated interaction data.

Multi-stage LLM 150 leverages the distributed thought cache to construct responses that appropriately balance AI reasoning with human cognitive patterns based on the current collaborative context. When cache hits occur across multiple cache tiers, LLM 150 orchestrates the combination of cached AI thoughts, human patterns, and collaborative templates to generate responses that maintain both semantic accuracy and collaborative appropriateness. This approach enables the system to achieve increasingly natural and effective human-AI interaction as the cache accumulates richer collaborative patterns over time.

The overall distributed thought cache architecture enables the PCM to achieve collaborative cognitive efficiency through geometric principles while maintaining privacy and supporting role adaptation. The system maintains responsiveness in collaborative scenarios by leveraging cached interaction patterns, achieves collective learning of human-AI collaboration strategies through federation, and preserves individual privacy through geometric abstraction. This architecture demonstrates that collaborative memory can accelerate human-AI partnership development through proper geometric organization and distributed coordination, enabling increasingly sophisticated and natural human-AI collaboration through the principled application of geometric memory management to both individual and collaborative cognition.

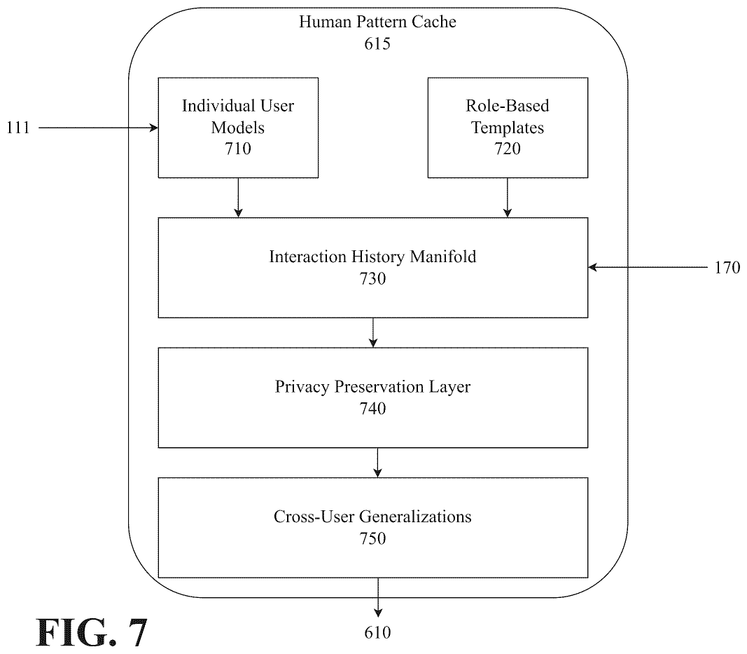

FIG. 7 is a block diagram illustrating an exemplary architecture of a human pattern cache 615 within a Persistent Cognitive Machine configured for adaptive role-based human-AI collaboration. Human pattern cache 615 operates as a specialized memory system dedicated to storing, organizing, and managing human cognitive patterns while maintaining strict privacy protections and enabling collaborative learning across multiple users and interaction contexts. This cache maintains a hierarchical organization that separates individual user data from generalized collaborative patterns, implementing multiple layers of abstraction and privacy protection to enable knowledge sharing while preserving user confidentiality.

Individual user models 710 store personalized cognitive profiles for each human participant who interacts with the system. This component maintains comprehensive representations of users'cognitive characteristics by encoding reasoning style patterns, problem-solving approaches, and decision-making tendencies derived from accumulated interaction data processed through human pattern encoder 111. Individual user models 710 creates and updates geometric representations that capture characteristic cognitive trajectories, preferred exploration patterns, and expertise distributions across different domains. The component continuously evolves these models based on demonstrated capabilities during interactions, reinforcing expertise indicators through successful problem-solving while identifying knowledge boundaries through struggles or assistance requests. Each user profile remains isolated within individual user models 710, maintaining distinct geometric encodings of attention distribution tendencies, conceptual association preferences, reasoning velocities, and interaction style preferences that influence how the system adapts its collaborative behavior for specific users.

Role-based templates 720 organize successful collaborative patterns according to the interaction modes in which they proved effective, creating a library of reusable strategies for different collaborative contexts. This component extracts and stores proven patterns from successful interactions across four role categories: teacher templates containing pedagogical sequences and scaffolding structures, student templates capturing effective learning and question-asking strategies, peer templates encoding balanced collaborative patterns for parallel exploration, and assistant templates storing task support strategies. Role-based templates 720 abstracts these patterns from specific instances to remove individual characteristics while preserving essential collaborative structures. The component continuously refines templates based on interaction outcomes and user feedback, building an evolving library of strategies that improve system-wide collaborative effectiveness without retaining user-specific information.

Interaction history manifold 730 maintains temporal records of collaborative interactions encoded as geometric structures within a dedicated manifold space. This component preserves geometric traces of human-AI interactions with sufficient fidelity to enable analysis and replay while preventing reconstruction of specific user inputs. Interaction history manifold 730 captures complete collaborative trajectories showing the interplay between human and AI contributions, moments of insight, knowledge transfer events, and patterns of effective cognitive coupling. The component specifically tracks role transition patterns, recording successful shifts between collaborative modes including trigger conditions, interpolation paths, and context preservation mechanisms. Additionally, interaction history manifold 730 monitors expertise evolution through temporal sequences showing how knowledge distributions change both within sessions and across extended interaction periods, capturing learning progressions and capability development patterns.

Privacy preservation layer 740 implements multiple protection mechanisms that transform human pattern data before any sharing or federation occurs. This component applies geometric abstraction through manifold projection techniques that map high-dimensional user-specific patterns onto lower-dimensional shared spaces, removing identifying features while preserving essential structural relationships. Privacy preservation layer 740 implements differential privacy by adding calibrated noise to pattern representations, with noise levels adapted based on pattern sensitivity to ensure mathematical guarantees against user identification even under adversarial analysis. The component also performs anonymization through rule-based and learned transformations that detect and remove temporal markers, linguistic patterns, and domain-specific knowledge that could reveal user identity. Throughout these transformations, privacy preservation layer 740 maintains the balance between privacy protection and collaborative utility, ensuring patterns remain useful for system learning while becoming impossible to trace back to individual users.

Cross-user generalizations 750 contain patterns that have been abstracted and aggregated across multiple users to create privacy-safe shared knowledge. This component combines similar cognitive patterns from different users into unified representations using statistical techniques including k-anonymity (ensuring patterns represent at least k users), l-diversity (maintaining attribute diversity), and t-closeness (keeping distributions close to population norms). Cross-user generalizations 750 extracts common strategies from multiple users'successful interactions, validating that patterns generalize across different users and contexts before promotion to shared storage. The component also maintains statistical measures of collaborative effectiveness including aggregate success rates, role transition distributions, and strategy effectiveness metrics that guide system optimization without exposing individual performance data.

Human pattern cache 715 operates through continuous data flow from human pattern encoder 111, which provides encoded cognitive patterns from ongoing interactions. These patterns flow through the cache hierarchy, initially entering individual user models 710 with full fidelity, potentially contributing to role-based templates 720 after successful interactions, being recorded in interaction history manifold 730 for temporal analysis, undergoing transformation in privacy preservation layer 740, and potentially joining cross-user generalizations 750 if proving broadly valuable. The connection to persistent memory manager 170 enables long-term storage with appropriate lifecycle management including thermodynamic decay for unused patterns and reinforcement for frequently accessed models. The connection to shared cache space 610 provides the pathway through which privacy-protected generalizations can be shared with the broader distributed system, enabling federated learning while maintaining strict privacy boundaries.

In an exemplary embodiment of operation, when a user demonstrates a novel problem-solving approach during collaborative interaction, human pattern cache 715 processes this pattern through its hierarchical structure. Individual user models 710 initially captures the pattern with full geometric fidelity, updating the user's expertise distribution and reasoning style representations. Upon successful task completion, role-based templates 720 evaluates the interaction for reusable strategies, abstracting user-specific features while preserving the collaborative approach that made it successful. Simultaneously, interaction history manifold 730 records the complete collaborative trajectory including role configurations and transition patterns. Privacy preservation layer 740 then applies geometric abstraction and differential privacy transformations, creating representations that preserve collaborative value while preventing user identification. If cross-user generalizations 750 identifies similar patterns from sufficient users meeting k-anonymity thresholds, it creates aggregated representations that enable system-wide learning. This hierarchical processing ensures that human pattern cache 715 can simultaneously support personalized user experiences through individual models while contributing to collective collaborative intelligence through privacy-safe generalizations, maintaining strict separation between private user data and shareable collaborative knowledge throughout its operation.

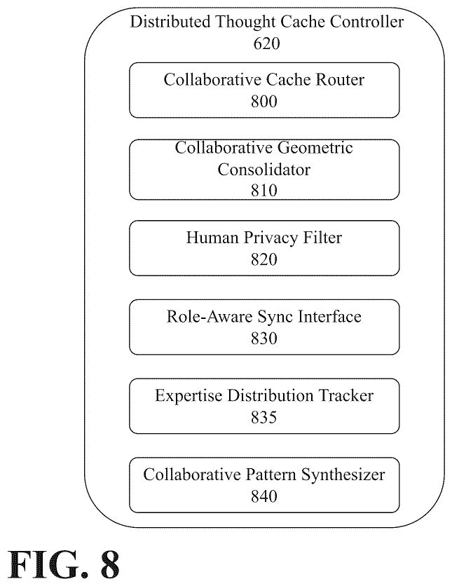

FIG. 8 is a block diagram illustrating an exemplary architecture of a distributed thought cache controller within the Persistent Cognitive Machine's distributed thought cache system configured for collaborative cognition. Distributed thought cache controller 620 implements routing logic, geometric consolidation algorithms, privacy-preserving transformations, federated synchronization protocols, and role-based cache management that together enable the remarkable scaling properties of the PCM's distributed memory system while supporting adaptive human-AI collaboration.

A collaborative cache router 800 serves as a decision engine determining whether incoming queries can be satisfied from cached thoughts, human patterns, or collaborative templates, or require full computation through the cognitive pipeline. Unlike traditional cache routers that perform simple key matching, collaborative cache router 800 implements multi-stage geometric matching that evaluates queries against cached content using sophisticated similarity measures within the curved space of the latent manifold while considering the current collaborative context and role configuration. When a query arrives from the multi-stage LLM along with human interaction signals, collaborative cache router 800 performs a rapid preliminary scan across multiple cache tiers (for example, AI thoughts, human patterns, and/or collaborative templates) using approximate nearest neighbor algorithms adapted for Riemannian metrics. The router then executes deeper geometric analysis on candidates, evaluating criteria including geodesic distance measuring paths through the manifold, semantic basin overlap for both AI and human cognitive regions, trajectory compatibility with the current collaborative role, human expertise alignment based on cached user models, and collaborative potential scoring that assesses how well cached patterns match the current interaction context. Collaborative cache router 800 implements role-adaptive thresholds that adjust based on the collaborative mode, permitting broader matches in exploratory peer collaboration while requiring precise matches in teacher mode where accuracy is paramount. For example, in a collaborative design scenario, the router might identify that a query about system architecture falls within the geometric neighborhood of previously successful human-AI design collaborations, enabling rapid response generation that leverages both cached AI reasoning and proven human interaction patterns.

A collaborative geometric consolidator 810 implements the function of merging and organizing cached thoughts, human patterns, and collaborative templates to prevent redundancy while improving retrieval efficiency and collaborative coherence. This component continuously monitors cache contents across all tiers: local AI thoughts, human patterns, and shared collaborative templates. This enables consolidator 810 to identify opportunities for consolidation based on geometric proximity, semantic overlap, and collaborative success metrics. Collaborative geometric consolidator 810 employs specialized algorithms for collaborative pattern consolidation including human-AI trajectory fusion where successful collaborative reasoning paths from different instances are merged into canonical collaborative templates, role-based bundle organization where similar interaction patterns are grouped by collaborative mode, expertise-weighted averaging that preserves important distinctions in knowledge distribution while consolidating common patterns, and collaborative abstraction where specific human-AI interactions are generalized into reusable role-based strategies. The consolidation process maintains separation between individual cognitive patterns and collaborative templates, ensuring that human privacy is preserved while collaborative knowledge is shared. For instance, as multiple PCM instances accumulate teaching interactions with different users, collaborative geometric consolidator 810 might identify common pedagogical patterns and create unified teaching templates that capture effective explanation strategies while removing individual-specific characteristics.

A human privacy filter 820 implements sophisticated geometric abstraction techniques specifically designed to protect human cognitive patterns and interaction data while enabling collaborative learning. When human patterns or collaborative interactions are selected for sharing, human privacy filter 820 applies transformations that preserve collaborative value while protecting individual privacy. These transformations include expertise abstraction that replaces specific knowledge profiles with generalized competency levels, cognitive style generalization that captures reasoning approaches without revealing individual thought patterns, interaction anonymization that preserves collaborative dynamics while removing identifying behaviors, and role-based projection that shares effective strategies without revealing participant identities. Human privacy filter 820 implements strict differential privacy guarantees for human data, ensuring that individual users cannot be identified from shared collaborative patterns. The filter maintains separate transformation protocols for AI thoughts (which may have different privacy requirements) and human patterns (which require maximum protection). For collaborative patterns, the filter creates composite representations that capture the joint dynamics without revealing either participant's individual characteristics. For example, when sharing a successful troubleshooting collaboration between a human expert and AI, human privacy filter 820 abstracts the human's domain-specific knowledge into general expertise indicators, replaces specific reasoning traces with categorical problem-solving approaches, and transforms the detailed interaction sequence into a reusable collaborative template.

A role-aware sync interface 830 manages the complex protocols for synchronizing cached thoughts, human patterns, and collaborative templates across multiple PCM instances while maintaining role consistency and collaborative context. This component implements synchronization algorithms that preserve the role-based organization of collaborative knowledge while managing the evolution of shared patterns across the federation. Role-aware sync interface 830 maintains awareness of the collaborative configurations active across different instances, tracking which roles are being utilized, which collaborative patterns prove most effective, and how expertise is distributed across the network. The interface implements role-specific synchronization modes including teacher pattern propagation for sharing effective pedagogical strategies, peer collaboration template distribution for balanced interaction methods, student interaction model sharing for learning optimization, and assistant pattern synchronization for task support strategies. The interface prioritizes synchronization based on collaborative value and role relevance, immediately propagating breakthrough teaching methods while using lazy synchronization for incremental refinements. Role-aware sync interface 830 also manages role transition patterns, sharing successful strategies for shifting between collaborative modes and maintaining continuity across role changes.

An expertise distribution tracker 835 maintains a dynamic map of knowledge distribution across both human and AI domains throughout the federated system. This component aggregates expertise indicators from multiple sources including cached human patterns showing user competencies, AI reasoning trajectories demonstrating system capabilities, collaborative success metrics indicating effective knowledge combinations, and error patterns revealing knowledge gaps. Expertise distribution tracker 835 creates federated expertise maps that help optimize cache routing and collaboration strategies, identifying which instances have developed strength in particular domains, where human expertise complements AI capabilities, and which collaborative patterns work best for different expertise distributions. This tracking enables intelligent routing of queries to appropriate cache contents based on expertise requirements and supports federated learning by identifying knowledge transfer opportunities.

A collaborative pattern synthesizer 840 actively generates new collaborative templates by analyzing successful interactions across the federation and identifying generalizable strategies. This component examines cached collaborative patterns to discover emergent collaboration techniques that arise from accumulated interactions, optimal role configurations for different task types, successful strategies for managing expertise differentials, and effective methods for maintaining engagement across extended collaborations. Collaborative pattern synthesizer 840 employs geometric interpolation to create new templates that blend successful strategies from different instances, generating novel collaborative approaches that haven't been explicitly programmed or observed. The synthesizer validates new patterns through geometric coherence checks and compatibility analysis before adding them to the shared cache. For example, by analyzing teaching patterns from multiple instances, the synthesizer might discover that alternating between demonstration and guided practice phases creates particularly effective learning experiences, generating a new pedagogical template that can benefit all instances.

The integration of these components within distributed thought cache controller 620 creates an orchestration layer that enables the PCM's distributed collaborative cognition capabilities. Collaborative cache router 800 ensures efficient query resolution that leverages both AI and human knowledge, collaborative geometric consolidator 810 maintains cache efficiency while preserving collaborative patterns, human privacy filter 820 enables secure knowledge sharing while protecting individual privacy, role-aware sync interface 830 coordinates the distributed evolution of collaborative intelligence, expertise distribution tracker 835 optimizes knowledge utilization across the federation, and collaborative pattern synthesizer 840 discovers new collaboration strategies from collective experience. Together, these components enable the distributed thought cache system to achieve logarithmic scaling in storage requirements for both individual and collaborative patterns, accelerated development of human-AI collaboration capabilities through federated learning, privacy-preserving sharing of collaborative strategies, and emergent collective intelligence in human-AI partnership. Distributed thought cache controller 620 thus serves as the enabler of scalable, secure, and effective distributed collaborative cognition in the PCM architecture.

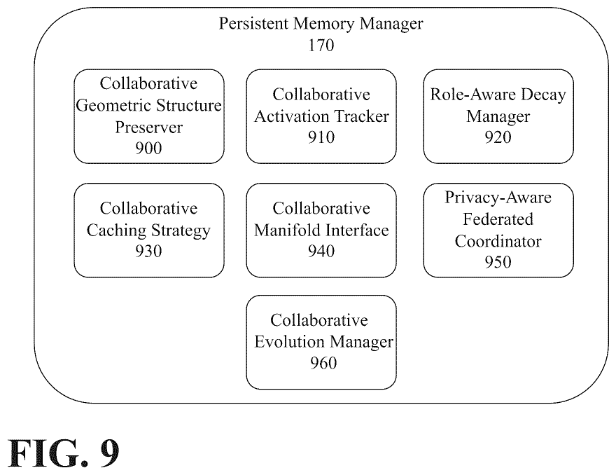

FIG. 9 is a block diagram illustrating an exemplary architecture of a component within a Persistent Cognitive Machine (PCM), a persistent memory manager configured for collaborative cognition. Unlike traditional memory systems that store static data in hierarchical caches, persistent memory manager 170 implements an approach where memory exists as living geometric structures within the latent manifold, subject to natural evolution through usage patterns, collaborative interactions, and energy dissipation. This component serves as the bridge between the dynamic latent manifold and long-term cognitive persistence, ensuring that both AI thoughts and human cognitive patterns (discrete units of reasoning or collaborative interaction generated during processing) are preserved not as isolated data points but as interconnected geometric structures with semantic and collaborative relationships intact.

A collaborative geometric preserver 900 maintains the fundamental geometric integrity of stored thoughts, human patterns, and collaborative interactions within the thought cache, a structured memory layer configured to store and retrieve cognitive structures based on semantic similarity, contextual alignment, collaborative success, and system policy. This component preserves AI thought bundles, human cognitive traces, and collaborative templates as compact submanifolds, maintaining their internal metric structure, boundary conditions, role-specific configurations, and topological relationships. When collaborative interactions are cached, collaborative geometric preserver 900 ensures that not only the content but also the complete collaborative context is maintained, including the expertise distribution at the time of interaction, the role configuration that shaped the collaboration, the geometric coupling between human and AI trajectories, and the success metrics of the collaborative outcome. For instance, when storing a successful collaborative problem-solving session, the component preserves the interleaved reasoning chain showing how human insights and AI analysis built upon each other, the role transitions that occurred during the session, and the geometric signatures of effective human-AI coupling. Collaborative geometric preserver 900 implements algorithms to handle the challenges of preserving dynamic collaborative structures, including maintaining consistency as both human models and AI manifolds evolve independently, preserving privacy boundaries while maintaining collaborative utility, and ensuring that collaborative patterns remain applicable across different human-AI pairs.

A collaborative activation tracker 910 implements the thermodynamic model of memory persistence with role-weighted energy assignments for different types of cognitive structures. Collaborative activation tracker 910 assigns and monitors activation energies to cached thoughts, human patterns, and collaborative templates using a multi-dimensional energy model where structures gain energy through various forms of engagement including direct retrieval for task completion, participation in successful collaborations, reinforcement through positive human feedback, and reuse as templates for new interactions. The tracker maintains separate energy landscapes for AI reasoning patterns (which may have different persistence requirements), human cognitive models (which require careful privacy-aware management), and collaborative templates (which gain energy from successful reuse across different human-AI pairs). Energy updates follow role-specific principles where teaching patterns receive energy boosts from successful knowledge transfer, peer collaboration patterns gain energy from balanced productive exchanges, and assistance patterns are reinforced by task completion metrics. The tracker implements collaborative energy inheritance where new collaborative patterns created through generalization inherit weighted energy from both their AI and human parent structures.

A role-aware decay manager 920 implements natural forgetting mechanisms that account for the different persistence requirements of various collaborative structures. This component executes differentiated decay equations where foundational AI knowledge decays slowly, specific human patterns decay more rapidly unless continuously reinforced, collaborative templates decay based on their generalization level and reuse frequency, and role-specific patterns have decay rates modulated by their collaborative utility. Role-aware decay manager 920 implements sophisticated pruning strategies for collaborative content, including preservation of successful collaboration patterns even when component parts decay, redistribution of collaborative insights to more general templates before specific instances fade, and maintenance of role transition trajectories that prove valuable for collaborative continuity. The manager ensures that privacy-sensitive human patterns decay appropriately while valuable collaborative abstractions persist, implementing contextual decay modulation where the uniqueness of collaborative strategies, their success rates, and their applicability across different scenarios influence decay rates.

A collaborative manifold interface 940 provides the bidirectional connection between persistent memory manager 170 and the latent manifold, enabling seamless flow of both individual and collaborative geometric structures. This interface implements specialized protocols for reading collaborative structures from memory into the active manifold, including reconstruction of human-AI interaction patterns with full collaborative context, restoration of role-specific geometric configurations, integration of human cognitive models with appropriate privacy boundaries, and alignment of collaborative templates with current participant characteristics. When writing updates back to memory, collaborative manifold interface 940 captures the complete collaborative evolution, preserving information about successful human-AI couplings, role transitions that enhanced collaboration, expertise exchanges between participants, and emergent collaborative strategies. The interface handles the complexity of maintaining multiple parallel representations for AI thoughts, human patterns, and their collaborative intersections, ensuring consistency while preserving the distinct characteristics of each cognitive system.

A collaborative caching strategist 930 implements intelligent policies for determining which thoughts, human patterns, and collaborative structures to preserve across various cache tiers, with particular attention to collaborative value and privacy requirements. This component implements multi-criteria decision making for cache management, considering geometric proximity within collaborative spaces, role-specific utility for different interaction modes, privacy constraints for human data, collaborative success metrics, and cross-instance generalization potential. Collaborative caching strategist 930 manages the distribution of content across cache tiers with role-based organization; maintaining high-value teaching templates in readily accessible tiers, storing personalized human models in privacy-protected local caches, and placing generalized collaborative patterns in shared tiers for federation. The strategist implements predictive caching for collaborative scenarios, anticipating which interaction patterns will be valuable based on user expertise profiles, task characteristics, and historical collaboration success.

A privacy-aware federated coordinator 950 enables knowledge sharing and synchronization across multiple PCM instances while maintaining strict privacy protections for human cognitive data and collaborative patterns. This coordinator implements differentiated sharing protocols where AI reasoning patterns can be shared with standard geometric abstraction, human cognitive patterns require maximum privacy protection with aggressive abstraction, and collaborative templates undergo selective sharing based on their generalization level and privacy implications. Privacy-aware federated coordinator 950 manages the challenges of cross-instance collaborative learning, including aligning collaborative patterns from different human-AI pairs while preserving participant anonymity, determining appropriate abstraction levels for collaborative templates to balance utility with privacy, and handling conflicts when different instances develop incompatible collaborative strategies. The coordinator implements consensus mechanisms for collaborative patterns that respect both local interaction dynamics and global collaborative learning objectives.

A collaborative evolution manager 960 orchestrates the mechanisms through which persistent memory structures adapt and improve over time with particular focus on enhancing collaborative capabilities. This manager implements evolution mechanisms specifically designed for collaborative enhancement, including reinforcement of successful human-AI interaction patterns through increased coupling strength, compression of redundant collaborative strategies into unified templates, abstraction of specific interactions into generalizable role-based strategies, and selective forgetting of ineffective collaborative patterns. Collaborative evolution manager 960 coordinates with dream manager operations to discover emergent collaborative strategies from accumulated interactions, optimize role transition sequences for smoother collaboration, and synthesize new collaborative templates from successful patterns across the federation. The manager implements scheduling algorithms that balance the evolution of individual cognitive capabilities with collaborative enhancement, ensuring that memory evolution improves both independent reasoning and human-AI partnership.

The components create a persistent memory system that supports both individual cognition and collaborative intelligence. Collaborative geometric preserver 900 maintains the rich relationships between thoughts and interaction patterns, collaborative activation tracker 910 and role-aware decay manager 920 implement natural memory dynamics for collaborative structures, collaborative manifold interface 940 enables integration with active collaborative cognition, collaborative caching strategist 930 optimizes for both efficiency and collaborative value, privacy-aware federated coordinator 950 enables collective learning while protecting individual privacy, and collaborative evolution manager 960 ensures continuous improvement of collaborative capabilities. This architecture implements structured memory where both individual thoughts and collaborative patterns are stored as positions or paths within an evolving manifold, supporting context-sensitive access to both AI knowledge and human interaction patterns, reinforcement of successful collaboration through traversal, privacy-preserving pruning of human data, and dynamic generalization of collaborative strategies. The result is a memory system that actively participates in the collaborative cognitive process, shaping and being shaped by the ongoing evolution of human-AI partnership within the geometric substrate of the PCM.

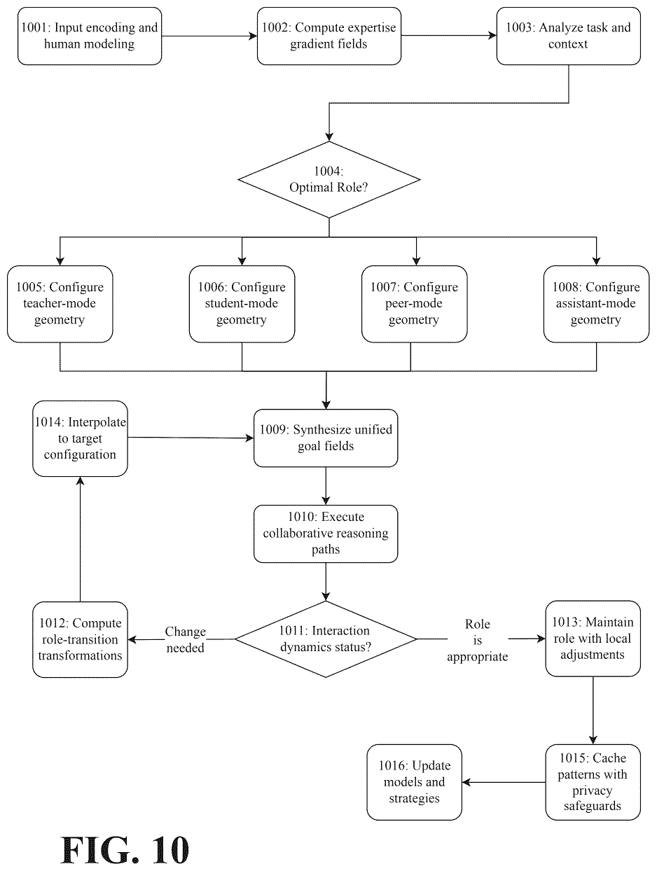

FIG. 10 is a flow diagram illustrating an exemplary process for adaptive role-based collaboration of a persistent cognitive machine, in an embodiment. The process may begin when a user initiates interaction with a persistent cognitive machine through user interface 101, triggering encoder 110 to process received input data while human pattern encoder 111 analyzes the interaction to derive cognitive style indicators, reasoning patterns, and expertise signals. The encoders may create dual geometric representations within latent manifold 160 that represent both the semantic content of the query and machine-encoded models of human cognitive characteristics 1001.

The encoded representations may be provided to expertise detector 420 within role adaptation manager 115, which may compare human cognitive pattern data with AI knowledge structures represented in latent manifold 160. This comparison may include measurement of relative density, semantic organization, and connectivity in relevant manifold regions to compute expertise gradients indicating areas of greater human knowledge, greater AI capability, or balanced expertise. These gradients may be encoded as scalar fields over the manifold for use in subsequent role determination 1002.

In parallel, role identifier 410 may analyze encoded task requirements to classify the interaction by parameters including task complexity, domain specificity, temporal constraints, and collaborative objectives. This analysis may generate task configuration signals specifying the determined task type, associated confidence levels, and alternative role or execution options 1003.

Role adaptation manager 115 may combine the expertise distribution from expertise detector 420 with the task configuration from role identifier 410 in a multi-criteria decision process to select a collaborative role. The selection may consider the magnitude of expertise differentials, the relationship between expertise distribution and task requirements, continuity with prior interactions as represented in human pattern cache 715, and projected potential for productive knowledge exchange. Based on this evaluation, the selected role may include teacher mode, student mode, peer mode, or assistant mode 1004.

When teacher mode is selected, role transition controller 430 may provide geometric transformation instructions to collaborative dynamics engine 130. The engine may increase curvature in designated pedagogical regions of latent manifold 160, creating compression effects that guide cognitive flow along structured instructional paths while limiting excessive information transfer between unrelated thought bundles. This may encourage traversal from foundational concepts toward more advanced concepts in a controlled manner 1005.

When student mode is selected, role transition controller 430 may instruct collaborative dynamics engine 130 to reduce curvature in the relevant manifold regions, enabling AI processes to follow human reasoning without predefined constraints. Sensitivity to human cognitive traces may be increased by amplifying the geometric influence of human pattern bundles and widening receptive fields to capture fine-grained aspects of human expertise, including intuitive reasoning and domain-specific heuristics 1006.

When peer mode is selected, the engine may adjust manifold geometry to create balanced curvature and symmetrical traversal properties, allowing human and AI processes to explore in parallel. Geodesic structures may be arranged to enable coordinated but independent investigations while maintaining opportunities for mutual reinforcement of reasoning 1007.

When assistant mode is selected, the engine may configure the manifold to allow fluid access across manifold regions with minimal transition overhead, prioritizing rapid retrieval of relevant information and task completion efficiency over exploration or instructional pacing 1008.

After the role-specific transformation, collaborative goal synthesizer 440 may combine explicit objectives obtained from the user input with implicit goals inferred from context and system objectives. Unified goal potential fields may be generated over latent manifold 160, attracting attention toward semantically relevant manifold regions with field characteristics adapted to the selected collaborative role 1009.

The system may execute collaborative reasoning within the configured manifold, using collaborative geodesic calculator 250 to determine traversal paths that account for human cognitive constraints and AI computational capabilities. Dual attention vector field 230 may coordinate human and AI attention flows according to the current collaborative role, with generated outputs reflecting the coordinated progression through relevant manifold regions 1010.

During collaborative reasoning, role adaptation manager 115 may monitor engagement metrics, performance indicators, and evolving expertise signals to determine whether the current role remains optimal. Detected conditions such as changes in user proficiency, indications of misunderstanding, or convergence toward shared solutions may prompt a role change 1011.

If a role change is indicated, role transition controller 430 may compute transformation paths that gradually adjust the metric tensor and other manifold parameters, preserving topological consistency and active reasoning continuity during the transition 1012.

If the current role remains optimal, the system may continue in the existing configuration while making localized adjustments to reinforce effective reasoning paths and maintain cognitive flow 1013.

Where a role transition is executed, the interpolation may progressively modify the manifold configuration until the target role's geometry is established, after which collaborative reasoning may resume in the new configuration 1014.

Upon task completion or the conclusion of a significant collaborative sequence, the resulting interaction patterns may be stored in human pattern cache 715. These stored patterns may undergo processing to update individual user models 710, role-based templates 720, and interaction history manifold 730, with privacy preservation layer 740 applying protective transformations before any generalized patterns are made available for sharing 1015.

The updated patterns may refine representations of the user's cognitive style and expertise distribution, influence subsequent role determinations, and inform adjustments to geometric configuration parameters and collaborative strategy selection in future interactions, completing the adaptive role-based collaboration cycle 1016.

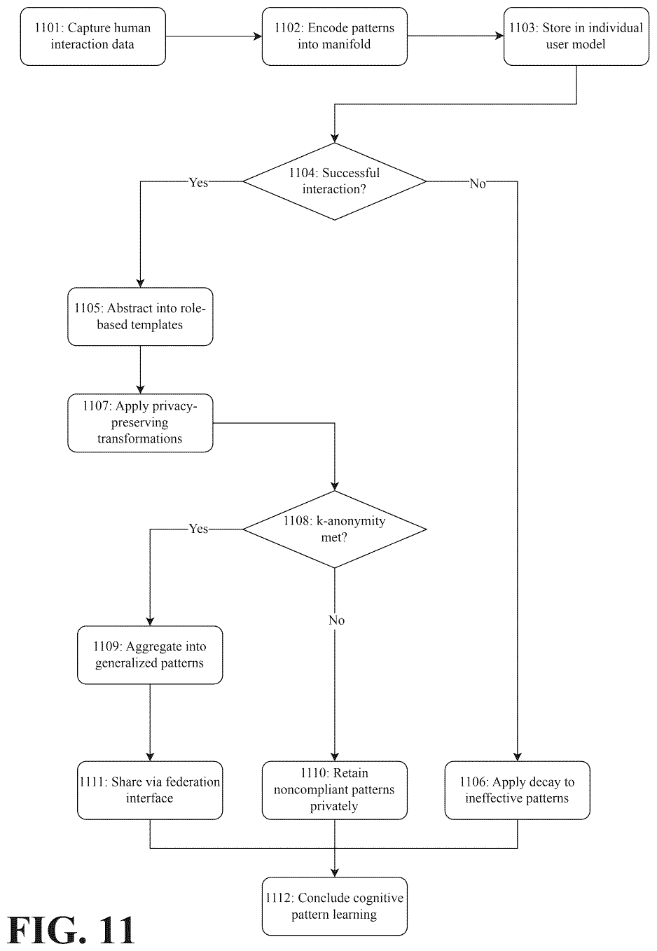

FIG. 11 is a flow diagram illustrating an exemplary method for learning human cognitive patterns within a persistent cognitive machine configured for adaptive role-based collaboration, in an embodiment. The process may begin when the system captures human interaction data through user interface 101. The capture may include various measurable signals such as natural language inputs, response timing information, correction events, exploration paths, and indicators of engagement or attention. The data collection may occur continuously during interaction to build a multi-faceted representation of the human's reasoning style and apparent expertise 1101.

The captured data may be processed by human pattern encoder 111, which may execute algorithms implemented in hardware or software to transform the behavioral signals into geometric structures within latent manifold 160. Such encoding may represent temporal reasoning sequences as geodesic trajectories, decision tendencies as curvature variations, expertise indicators as density distributions, and cognitive preferences as adjustments to local metric tensor properties. The result may be a high-dimensional representation that preserves key characteristics of the human cognitive process while omitting specific task content to allow reuse in other contexts 1102.

The encoded patterns may be stored in individual user models 710 within human pattern cache 715. These models may be updated by reinforcing patterns that are consistent with prior observations, adding new structures for novel reasoning approaches, adjusting expertise distributions to reflect demonstrated capabilities, and maintaining continuity between related patterns across separate sessions through stored connection data 1103.

The system may then assess the interaction using measurable performance indicators such as task completion results, error frequency, correction patterns, engagement metrics, and comparative efficiency values. This assessment may produce a score or other evaluation signal usable to determine whether the observed patterns should be emphasized, generalized, retained for limited use, or reduced in influence over time 1104.

Patterns derived from interactions assessed as effective may be analyzed for reusable strategies and abstracted into role-based templates 720. This abstraction may remove any information that could identify a specific user while maintaining the functional structure of the collaborative approach. Patterns may be organized according to the role configuration in which they were effective, such as teacher, student, peer, or assistant roles, and stored in parameterized form to allow adaptation for different users and scenarios 1105.

Patterns from interactions assessed as ineffective may be adjusted by role-aware decay manager 920. This adjustment may involve gradually reducing the likelihood of pattern reuse according to stored decay functions that can take into account the distinctiveness of the pattern, its difference from patterns known to be successful, and its possible applicability in other contexts. Decay rates may vary based on these factors so that some patterns are forgotten quickly while others persist for possible later application 1106.

Patterns selected for potential sharing or reuse outside the originating user model may undergo privacy processing through privacy preservation layer 740. This may include geometric abstraction that maps high-dimensional, user-specific structures to lower-dimensional forms, the addition of controlled statistical variation to obscure identifying details, and removal of elements such as temporal markers, linguistic artifacts, or domain-specific identifiers 1107.

The privacy-preserved patterns may be evaluated against a k-anonymity threshold, where k may be a selected value such as at least 5, to verify that each pattern represents a sufficiently broad set of users to meet predetermined privacy criteria. This verification may also check for diversity of contributing users and confirm that collaborative utility is maintained in the generalized pattern 1108.

Patterns meeting these criteria may be aggregated with other compatible patterns in cross-user generalizations 750 using one or more statistical or geometric combination processes. This may include weighted merging of structures, consensus-driven selection of reasoning paths, or synthesis of new generalized structures that reflect common strategies while accommodating population variability 1109.

Patterns not meeting the sharing criteria may remain in private storage within human pattern cache 715 for use in future interactions with the originating user, where they may retain their full structural fidelity to optimize personalized collaboration while being excluded from any shared or federated datasets 1110.

Generalized patterns approved for sharing may be transferred to distributed cache 610 via collaborative federation interface 655. The interface may implement exchange protocols that maintain semantic consistency while aligning the transferred pattern to the receiving system's manifold configuration, enabling other persistent cognitive machine instances to benefit from the collaborative strategies without exposing individual user data 1111.

At the conclusion of this process, human cognitive patterns may have been captured, processed, stored, and, where appropriate, generalized and shared. The resulting structures may persist in the system's memory, enabling more effective and adaptive collaboration over time while maintaining strict privacy separation between individual user information and shared collaborative resources 1112.

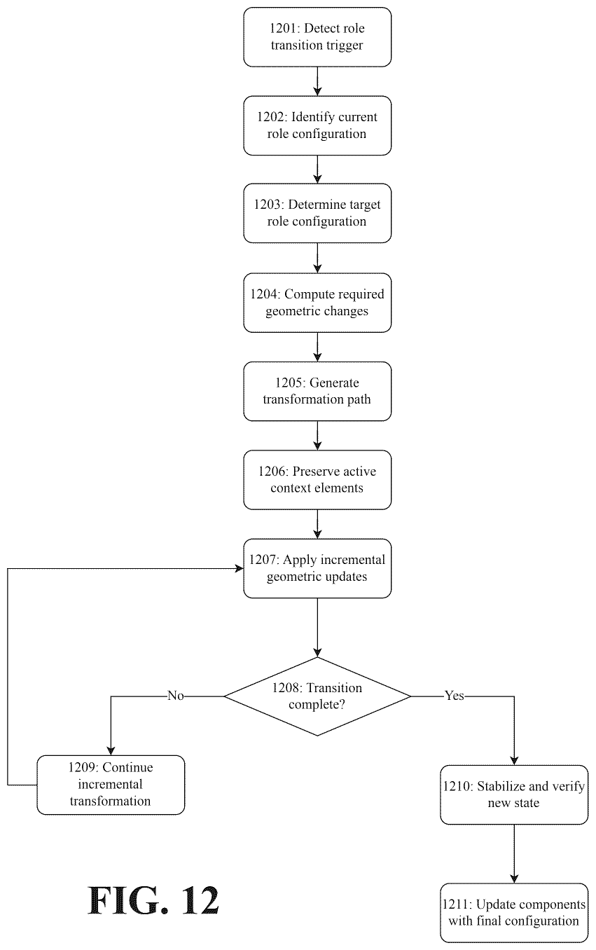

FIG. 12 is a flow diagram illustrating an exemplary method for dynamic role transition within a persistent cognitive machine configured for adaptive role-based collaboration, in an embodiment. The process may begin when the system identifies a potential role transition based on signals detected by role adaptation manager 115 during ongoing monitoring. Such signals may include changes in the relative distribution of knowledge between human and AI participants, modifications to task requirements as a problem progresses, or user-initiated requests for a different style of support. The system may evaluate these signals against configurable thresholds that are designed to maintain stability while permitting timely response 1201.

When a transition is to be performed, role state manager 365 may determine the current role configuration by obtaining information from latent manifold 160 regarding the state of its stored representation. This may include data defining the current metric tensor values that govern distance relationships, curvature values across manifold regions, coupling parameters between human and AI cognitive processes, and the status of active goal potential fields from collaborative goal synthesizer 440. This information may serve as the source configuration for the planned transition 1202.

Role identifier 410 may then determine the target role configuration based on the updated task context and expertise distribution that led to the trigger. Factors considered may include the magnitude and trend of the expertise change, the correspondence between available capabilities and evolving task demands, previously stored examples of effective roles in similar circumstances, and projected collaborative performance for each candidate role. The target role may be selected to improve the likelihood of successful completion of the current objective 1203.

Collaborative curvature computer 310 may determine changes to manifold geometry that would produce the target role configuration. These changes may include modifying stored metric tensor values to reshape distance relationships, adjusting curvature values to alter traversal characteristics, and updating coupling parameters to reflect the desired interaction level between human and AI processes. For example, in some embodiments, teacher mode may be associated with increased curvature in selected regions, while student mode may use reduced curvature to allow more open exploration 1204.

Role transition controller 430 may generate a transformation path between the current and target configurations that remains within the set of valid manifold states. In some embodiments, the path may be computed to minimize computational cost while maintaining smooth changes in stored geometric properties to reduce disruption to ongoing processes. The transition rate may be set according to the urgency of the change and the scale of the required adjustments 1205.

Before carrying out the transformation, collaborative memory manager 340 may preserve active data structures that are intended to remain intact across the transition. These may include representations of current goals, partial reasoning sequences, and collaborative memory elements held in persistent memory manager 170 that capture shared understanding achieved during the interaction. Such elements may be tagged to ensure they are preserved and reintegrated during the reconfiguration 1206.

Collaborative dynamics engine 130 may then apply the geometric changes to the stored manifold representation in a gradual manner, modifying metric tensor values and curvature parameters in increments determined by the transformation path, and updating coupling strengths through human-AI coupling calculator 375 to match the new role's interaction profile 1207.

During the transformation, role transition controller 430 may monitor whether the stored manifold state is approaching the target configuration by checking parameters such as the difference between current and target metric tensor values, stability measures for the evolving configuration, and continuity of preserved context elements. Monitoring may also include tracking whether collaborative attention flows remain coherent for both participants 1208.

If the target configuration has not been reached, the transition may proceed with additional incremental updates, with the rate of change adjusted as needed to maintain stable operation and uninterrupted collaborative reasoning 1209.

The continuation of interpolation may involve returning to the transformation execution step, where collaborative dynamics engine 130 applies the next increment of geometric change. This process may be repeated until the manifold representation has fully transitioned to the target configuration, while maintaining collaborative functionality and preserving the semantic relationships among active thought processes.

Once the target configuration is reached, the system may stabilize the new state. Stabilization may include allowing temporary fluctuations in metric tensor values to diminish, reinforcing the updated geometry through traversal of key paths, recording new baseline curvature and coupling measurements for use in future transitions, and confirming that preserved context elements have been successfully reintegrated into the new configuration 1210.

The process may conclude with the system updating all relevant components to reflect the finalized role configuration, including metric tensor values, curvature parameters, coupling strengths, and goal potential fields. These updates may be propagated to ensure that all subsystems operate consistently within the new collaborative mode while retaining the accumulated shared understanding between human and AI participants 1211.

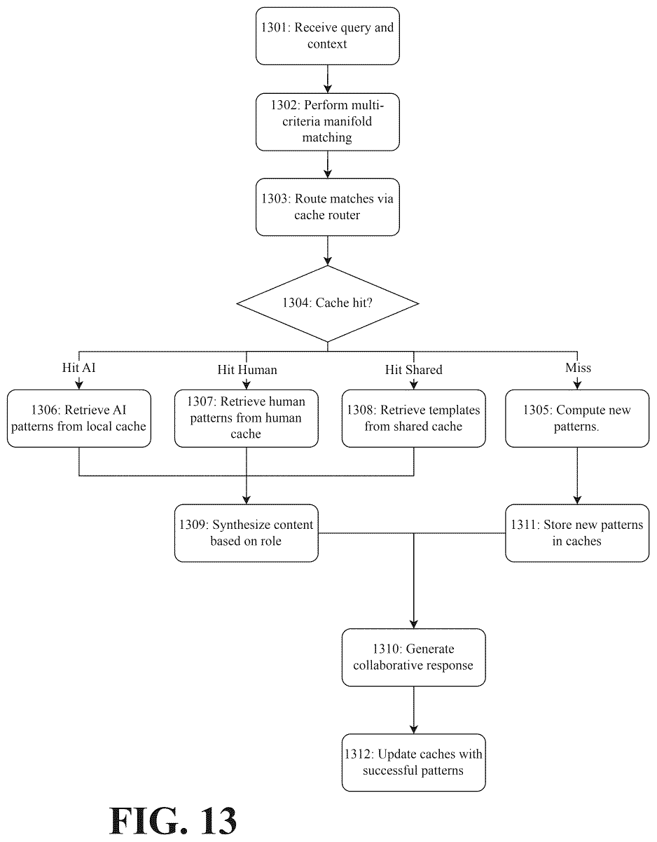

FIG. 13 is a flow diagram illustrating an exemplary method for distributed thought caching of human patterns in a persistent cognitive machine configured for adaptive role-based collaboration, in an embodiment. The process may begin when the system receives a query through user interface 101 along with collaborative context information. Such context may include the current role configuration, user expertise indicators from human pattern encoder 111, and task requirements encoded by encoder 110 1301.

Upon receiving the query and collaborative context, the system may perform a multi-criteria matching operation within a stored representation of latent manifold 160. This matching may involve comparing the query to cached content based on one or more measures including AI thought similarity derived from geodesic distance calculations, overlap between semantic regions in the manifold, compatibility of current human cognitive style indicators with stored human pattern data in human pattern cache 715, and alignment between cached collaborative templates and the active interaction role, such as teacher, student, peer, or assistant modes 1302.

The matching results may be evaluated by collaborative cache router 800 within distributed thought cache controller 620. This component may apply routing logic that takes into account both semantic relevance and collaborative compatibility, with match thresholds adjusted according to the active role configuration. In some embodiments, broader matches may be permitted during exploratory peer collaboration, while narrower thresholds may be used in modes requiring higher precision such as teacher mode 1303.

Collaborative cache router 800 may then determine whether any cached content satisfies the applicable thresholds for the query and collaborative context. This determination may be based on geometric proximity scores, assessments of role compatibility, and evaluations of potential collaborative benefit 1304.

If no suitable cached content is found, the system may treat the condition as a cache miss and proceed with new computation through the cognitive pipeline. This may involve collaborative dynamics engine 130 computing new geodesic paths through latent manifold 160 while applying constraints and priorities based on both human cognitive considerations and AI computational capabilities 1305.

If a cache hit is found in local thought cache 600, the system may retrieve AI-generated thought bundles along with associated geometric data such as local curvature patterns, geodesic relationships, and stored activation energy values indicating relative freshness and past utility 1306.

If a cache hit is found in human pattern cache 715, the system may retrieve stored human cognitive pattern data including reasoning style encodings, expertise distribution information, and collaborative preference indicators. These stored elements may have been processed through privacy preservation layer 740 to remove identifying characteristics before storage 1307.

If a cache hit is found in shared cache space 610, the system may retrieve generalized collaborative templates abstracted from multiple human-AI interactions across federated instances. Such templates may preserve role-specific strategies and proven collaboration methods while omitting information that could identify individual participants 1308.

The retrieved elements from any cache tier may be combined using a role-aware synthesis procedure. This may involve weighting, merging, or filtering content to produce a combined structure suitable for the active role configuration. For example, in some embodiments, teacher mode may emphasize AI reasoning content, student mode may give greater weight to human-derived patterns, peer mode may aim for balanced integration, and assistant mode may prioritize speed and task efficiency 1309.

The combined result, or newly computed patterns if a cache miss occurred, may be provided to multi-stage LLM 150. This component may generate a collaborative response that integrates AI reasoning and human cognitive patterns according to the active role, producing outputs designed to be both semantically accurate and contextually appropriate 1310.

When new patterns are computed, the system may store them in one or more cache tiers. AI reasoning structures may be stored in local thought cache 600, human cognitive patterns may be processed through privacy preservation layer 740 and stored in human pattern cache 715, and generalized collaborative strategies may be abstracted and stored in shared cache space 610 for possible federation-wide use 1311.

Following response generation, the system may update caches with patterns and strategies that proved effective during the interaction. This may include increasing activation energy values for retrieved content that was successfully applied, storing newly discovered collaborative templates, updating user-specific models in human pattern cache 715, and, where privacy and utility criteria are met, promoting generalized patterns to cross-user generalizations 750 1312.

The process may conclude with the distributed thought cache having either retrieved and synthesized suitable cached content or computed and stored new collaborative patterns, enabling reuse in future interactions. In some embodiments, this tiered caching process may reduce long-term storage growth and retrieval cost while supporting increasingly effective role-adaptive human-AI collaboration.

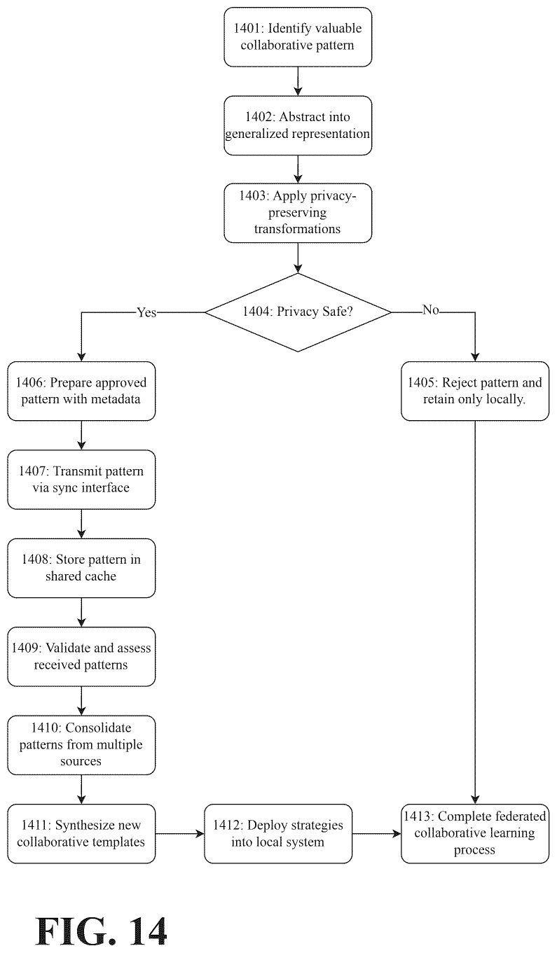

FIG. 14 is a flow diagram illustrating an exemplary method for federated collaborative learning in a persistent cognitive machine configured for adaptive role-based collaboration, in an embodiment. The process begins when collaborative pattern synthesizer 840 identifies a collaborative pattern with potential value for wider use. The synthesizer monitors performance metrics from human-AI interactions by examining data from local thought cache 600, human pattern cache 715, and collaborative thought bundles in latent manifold 160. Identification is based on criteria such as task completion rates, efficiency improvements, effective role transitions, or novel coordination strategies 1401.

Upon identifying such a pattern, collaborative geometric consolidator 810 performs geometric abstraction to generate a generalized representation. Instance-specific information, including user-identifying features, task-specific content, and timing markers, is removed. The abstraction retains essential structural relationships between human and AI contributions, the role configurations associated with success, and any recorded transitions between roles 1402.

Human privacy filter 820 applies privacy-preserving transformations to the abstracted pattern. Operations include removal of any residual identifying features such as linguistic idiosyncrasies or unique knowledge markers, insertion of controlled statistical variation to provide differential privacy protection, and verification of compliance with a selected k-anonymity threshold, for example a representation from at least a configured number of distinct users 1403.

Privacy-aware federated coordinator 950 validates that the privacy and utility requirements are met. This includes confirming differential privacy parameters, verifying k-anonymity compliance, ensuring the absence of identifiable elements, and assessing whether the transformed pattern retains sufficient structural fidelity to remain useful to other instances 1404.

If the pattern fails validation, the system retains it only within human pattern cache 715 for continued local use and blocks it from federation distribution 1405.

If the pattern passes validation, collaborative federation interface 655 prepares it for distribution. Preparation includes associating metadata such as the role type in which the pattern was effective, applicable task or domain categories, performance indicators, and version information for compatibility across different PCM instances 1406.

Role-aware sync interface 830 transmits the prepared pattern to other PCM instances, coordinates synchronization schedules, prioritizes high-value patterns for immediate propagation, handles incremental updates, and manages resolution of conflicting strategies between instances 1407.

The transmitted pattern is stored in shared cache space 610, making it accessible to participating PCM instances. Federation communication protocols maintain cryptographic integrity of the pattern during transmission, and origin metadata is preserved for quality assessment and lineage tracking 1408.

While sharing patterns, the system also receives patterns from other PCM instances. Each incoming pattern is validated for compatibility with the local manifold representation, evaluated for potential benefit to the local user base, and confirmed to meet local privacy and security requirements 1409.

Collaborative geometric consolidator 810 processes patterns from multiple sources. Consolidation includes detecting overlaps, merging similar strategies, resolving conflicts using automated selection mechanisms, and organizing patterns into role-based categories for efficient retrieval 1410.

Collaborative pattern synthesizer 840 analyzes the consolidated pattern set to derive new collaborative templates. This synthesis identifies combinations of strategies that improve results, refines role configurations effective across diverse contexts, and develops overarching structures for combining collaborative approaches 1411.

The system deploys the synthesized strategies by updating role-based templates 720, adjusting collaborative manifold regions 204 to reflect improved geometries, refining role selection criteria in role adaptation manager 115, and modifying transformation logic in collaborative dynamics engine 130 1412.

The process concludes with the local PCM instance having contributed valuable patterns to the federation and integrated beneficial patterns from other instances, thereby enhancing collaborative performance across the network while maintaining privacy protections and preserving local customization 1413.

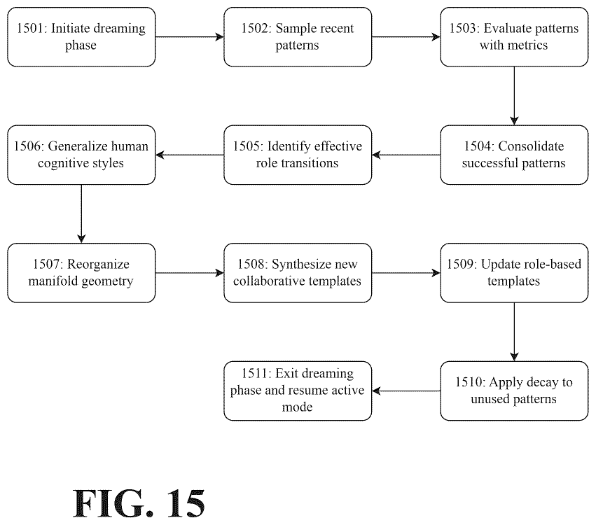

FIG. 15 is a flow diagram illustrating an exemplary method for collaborative manifold reorganization during a dreaming phase of a persistent cognitive machine configured for adaptive role-based collaboration, in an embodiment. The process begins during an idle period when dream manager 140, through collaborative dreaming interface 350, detects reduced activity and initiates autonomous reorganization. The purpose of the dreaming phase is to consolidate collaborative learning, adjust manifold geometry for improved human-AI interaction, and derive new collaboration strategies from stored experience 1501.

The system samples recent patterns from multiple sources. This includes retrieving AI reasoning traces from local thought cache 600 representing computational paths through latent manifold 160, extracting human interaction patterns from human pattern cache 715 representing reasoning styles observed in recent collaborations, and accessing collaborative trajectories from interaction history manifold 730 that capture integrated human-AI problem-solving sequences 1502.

Collaborative thought valuator 260 evaluates the sampled patterns using stored metrics. Metrics can include task completion rates, synchronization of human and AI attention flows, stability of role configurations, efficiency of knowledge transfer, generation of new ideas in peer modes, and engagement indicators recorded during use 1503.

Collaborative memory manager 340 consolidates patterns that meet success thresholds. Consolidation may merge similar patterns into unified templates, strengthen stored connections between concepts frequently associated in successful collaborations, create hybrid human-AI thought bundles, and define collaborative neighborhoods in the manifold where related interactions are grouped for faster retrieval 1504.

Interaction history manifold 730 is analyzed to identify effective role transitions. The system records transformation paths that maintained collaborative continuity while adapting to changes in expertise, identifies intermediate states that assist smooth transitions, and computes low-energy transition routes between role configurations 1505.

Dream manager 140 generalizes human cognitive styles by processing individual user models 710 to derive broader categories that represent common reasoning approaches. This step abstracts individual details to preserve privacy, identifies cognitive tendencies common across domains, links cognitive styles to preferred collaboration modes, and generates adaptable parameterized models 1506.

Collaborative dynamics engine 130 reorganizes manifold geometry to improve collaboration efficiency. This can involve shortening distances along frequently used collaborative paths, increasing curvature in regions associated with low success rates to discourage traversal, and establishing new connections between human and AI knowledge regions that can produce beneficial combinations 1507.

Collaborative pattern synthesizer 840 generates new collaborative templates by blending elements from multiple successful patterns, combining attributes of different collaboration modes, developing higher-level templates that specify how to use other templates in sequence, and identifying new strategies that arise from the reorganized manifold 1508.

The resulting templates and strategies update role-based templates 720 in human pattern cache 715. Updates can replace outdated strategies, add new strategies organized by role type and task category, adjust parameters based on aggregated performance data, and maintain version control to track template evolution 1509.

Role-aware decay manager 920 reduces the influence of patterns not recently used. Decay is applied at rates that vary according to pattern type, with slower decay for core strategies and faster decay for specific-instance patterns. Energy from decayed patterns is redistributed to strengthen active successful templates, ensuring the manifold remains uncluttered 1510.

The process concludes when the system exits the dreaming phase and returns to active mode. At this point, collaborative cognitive structures have been reorganized by consolidating effective patterns, optimizing manifold geometry, discovering new strategies, and removing less effective approaches, improving the system's ability to collaborate in future interactions 1511.

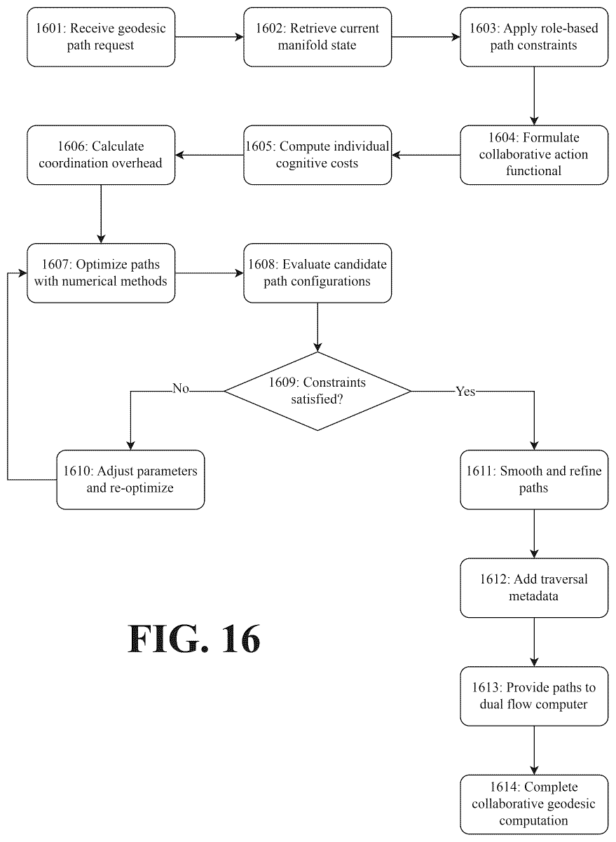

FIG. 16 is a flow diagram illustrating an exemplary method for collaborative geodesic path computation within a persistent cognitive machine configured for adaptive role-based collaboration, in an embodiment. The process begins when collaborative geodesic calculator 250 receives a request to compute optimal traversal paths through latent manifold 160. The request is triggered by a collaborative task requiring coordinated reasoning between human and AI participants and includes initial positions for each participant in the manifold, target goal states or semantic regions to be reached, and the active collaborative role configuration from role state manager 365 1601.

Collaborative dynamics engine 130 provides the current manifold state for use in path computation. Retrieved information includes metric tensor values defining local distance relationships, curvature tensor values from collaborative curvature computer 310 indicating semantic density and compression effects, expertise gradient field 215 showing relative human and AI knowledge distribution, and collaborative goal potential field 220 indicating task-relevant attraction regions 1602.

Role state manager 365 specifies role-based path constraints. For example, teacher mode applies constraints that order traversal from foundational to advanced concepts; student mode applies constraints allowing AI to follow human reasoning; peer mode establishes constraints supporting independent but synchronized paths; and assistant mode applies constraints minimizing traversal time for rapid completion 1603.

Collaborative geodesic solver 320 formulates a variational problem by defining a collaborative action functional with multiple cost components. Components include kinetic energy terms for both human and AI attention shifts derived from traversal velocity, potential energy from compression pressure field 210 weighted by participant expertise, attraction terms from collaborative goal potential field 220, and coordination cost terms that reflect divergence penalties based on coupling strength from human-AI coupling calculator 375 1604.

The solver evaluates individual cognitive costs. Human costs can include conceptual complexity limits, attention capacity, and preferred reasoning pace from human pattern cache 715. AI costs can include processing demands, memory access requirements, and inference complexity for the manifold regions along the path 1605.

Coordination overhead is computed by estimating synchronization cost to maintain alignment between participants. This cost depends on the role configuration, requiring tight synchronization in peer mode, asymmetric synchronization in teacher-student roles, and minimal synchronization in assistant mode, and adjusts for expertise differences between participants 1606.

The solver applies numerical optimization methods to minimize the collaborative action. Methods can include paired Riemannian gradient descent optimizing both trajectories with coupling constraints, collaborative shooting methods projecting initial velocities forward under role constraints, and consensus-based relaxation refining path segments until convergence 1607.

Candidate path configurations are evaluated against the collaborative context. Examples include parallel paths at different abstraction levels converging at synthesis points, alternating lead-follow paths determined by local expertise, and tightly coupled paths for intensive joint reasoning 1608.

Computed paths are checked for constraint compliance. Checks include remaining in valid manifold regions, avoiding inappropriate crossing of expertise boundaries, ensuring human cognitive load limits are respected, confirming synchronization points align with reasoning breakpoints, and verifying total path length and traversal time satisfy task requirements 1609.

If constraints are not met, the solver adjusts parameters such as coupling weights, synchronization thresholds, or search space scope, and repeats optimization until compliance is achieved 1610.

When constraints are satisfied, path smoothing is applied. This includes removing oscillations or sharp turns that could disrupt reasoning, interpolating intermediate waypoints for continuity, and adjusting curvature to maintain appropriate pacing for both participants 1611.

The system associates traversal metadata with the paths. Metadata can include pacing recommendations for different segments, synchronization markers for reasoning alignment, role transition points where mode changes could improve performance, and complexity indicators highlighting cognitively demanding regions 1612.

The optimized paths are provided to dual flow computer 330. The dual flow computer uses the paths to guide human and AI attention flow during collaboration, applying them as preferred trajectories while allowing for adaptive local exploration 1613.

The process concludes with collaborative geodesic calculator 250 having produced paths tailored to the collaborative role, balanced for human and AI constraints, synchronized for effective interaction, and optimized for guiding both participants toward task completion within the manifold 1614.

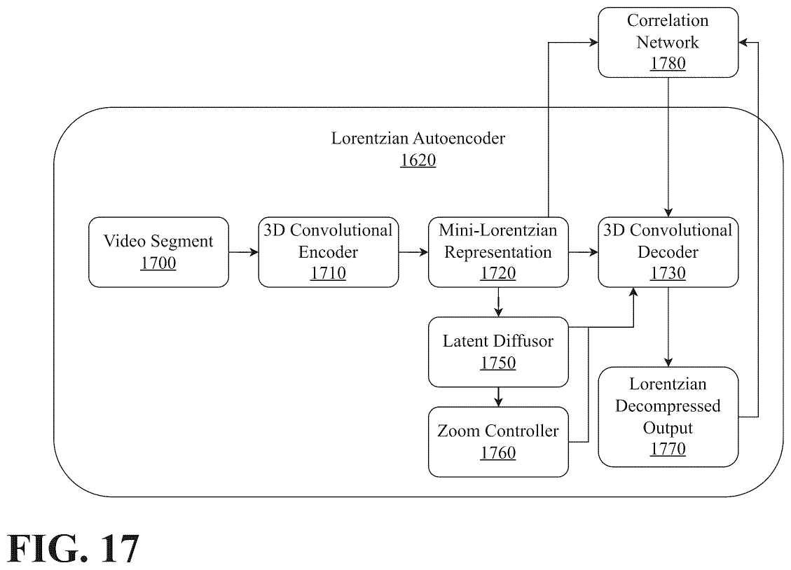

FIG. 17 is a block diagram illustrating an exemplary architecture for a subsystem of the system for video-focused compression with hierarchical and Lorentzian autoencoders, a Lorentzian autoencoder. Lorentzian autoencoder 1620 is designed for processing video data while preserving spatiotemporal relationships throughout the compression and restoration process. The autoencoder contains multiple specialized components that work together to achieve efficient compression and high-quality restoration of video content. The process begins with a video segment 1700 which serves as the input to Lorentzian autoencoder 1620. This video segment represents a sequence of video frames structured as a three-dimensional tensor, where the dimensions correspond to height, width, and time. The tensor format enables the system to process spatial and temporal information simultaneously, preserving important relationships that might be lost in traditional frame-by-frame processing approaches. The video segment may be extracted from a larger video stream by a video frame extractor, with appropriate preprocessing and normalization applied before reaching the Lorentzian autoencoder.

Video segment 1700 is first processed by a 3D convolutional encoder 1710, which applies a series of three-dimensional convolutional operations to the input tensor. Unlike traditional two-dimensional convolutional networks that process images, 3D convolutional encoder 1710 operates across both spatial and temporal dimensions simultaneously. This approach allows the encoder to capture spatiotemporal patterns and dependencies within the video data. The 3D convolutional operations progressively reduce the dimensions of the input tensor while increasing the feature depth, effectively compressing the video data into a more compact representation. 3D convolutional encoder 1710 may employ various architectural elements such as pooling layers, activation functions, and skip connections to optimize the encoding process for different types of video content and compression requirements.

The output of the 3D convolutional encoder 1710 is a mini-Lorentzian representation 1720, which is a compressed version of the original video segment that maintains the tensor structure. The mini-Lorentzian representation preserves the three-dimensional nature of the original data but with reduced spatial and temporal dimensions and potentially increased feature channels. This compressed representation serves as the central element of Lorentzian autoencoder 1620, connecting to multiple subsequent processing components. The mini-Lorentzian representation 1720 maintains matrix and tensor structures in the latent space, rather than flattening to vectors as is common in traditional autoencoders. This structural preservation enables more effective modeling of complex relationships within the video data and supports advanced features such as infinite zoom capabilities.

From the mini-Lorentzian representation 1720, the data follows multiple paths within the autoencoder. One path leads to 3D convolutional decoder 1730, which is responsible for reconstructing the original video data from the compressed representation. 3D convolutional decoder 1730 performs operations that are essentially the inverse of the encoder, progressively expanding the spatial and temporal dimensions while reducing the feature depth. The decoder may employ transposed convolutions, upsampling operations, and other techniques to effectively reconstruct the video data from its compressed form. The decoder's architecture often mirrors that of the encoder, potentially with skip connections between corresponding encoder and decoder layers to preserve fine details that might otherwise be lost during compression.

Another path from mini-Lorentzian representation 1720 leads to latent diffusor 1750, which models and analyzes the dynamics of the latent space. The latent diffusor examines patterns and trajectories within the mini-Lorentzian representation to understand how features evolve over time. This component plays a role in temporal prediction and synthesis, enabling the system to generate coherent video content beyond what was explicitly encoded in the compressed representation. Latent diffusor 1750 provides information to 3D convolutional decoder 1730, enhancing its ability to reconstruct temporally consistent and visually plausible video sequences. Latent diffusor 1750 may incorporate recurrent neural network architectures, attention mechanisms, or other specialized components designed to capture temporal dependencies and patterns.

Mini-Lorentzian representation 1720 also connects to correlation network 1780. Correlation network 1780 can identify patterns and similarities across different compressed representations, enabling it to recover information that might have been lost during compression. The output from correlation network 1780 flows back to the 3D convolutional decoder 1730, providing additional information that enhances the quality of the reconstructed video.

Latent diffusor 1750 connects to a zoom controller 1760, which manages the infinite zoom capability of the system. Zoom controller 1760 uses information about the latent space dynamics to generate additional details when zooming into specific regions of the video. By understanding the structured nature of the mini-Lorentzian representations across different scales, the zoom controller 1760 can direct the decoder to synthesize plausible fine details even beyond the resolution of the original video. Zoom controller 1760 also provides input to 3D convolutional decoder 1730, influencing how it reconstructs the video data based on the desired zoom level and region of interest.

The final output of Lorentzian autoencoder 1620 is a Lorentzian decompressed output 1770, which represents the restored video segment after all processing stages. This output maintains the tensor structure of the original input but with potentially enhanced quality due to the restoration capabilities of the various components within the autoencoder. Lorentzian decompressed output 1770 may then be further processed by the correlation network 1780 as part of the broader system, where it can be integrated with outputs from the hierarchical autoencoder to produce the final reconstructed output. Lorentzian autoencoder 1620 architecture represents a significant advancement in video compression technology, enabling higher compression ratios while maintaining better visual quality and supporting advanced features such as infinite zoom. The preservation of tensor structure throughout the processing pipeline allows for more effective modeling of spatiotemporal relationships, resulting in superior compression and restoration performance compared to traditional approaches that process video frames independently or flatten the data to vectors in the latent space.

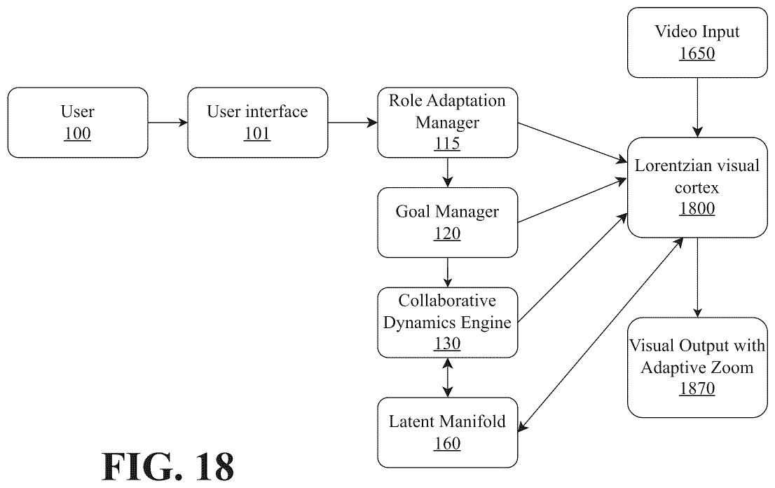

FIG. 18 is a block diagram illustrating an exemplary high-level integration architecture between a Persistent Cognitive Machine and a Lorentzian Visual Cortex subsystem for adaptive zoom and focus operations. The system represents a fundamental advancement in cognitive video processing by enabling intelligent supervision of Lorentzian autoencoder operations through PCM's collaborative intelligence architecture. Unlike traditional video processing systems that operate with fixed parameters, this integrated architecture dynamically adapts zoom behavior, focus selection, and geometric operations based on real-time cognitive assessments of expertise distribution, collaborative context, and human interaction patterns.

The system receives input from user 100 through user interface 101, with video input 1650 providing the visual data stream for processing. The video input flows into the Lorentzian Visual Cortex subsystem, which operates as an integrated processing block containing multiple specialized components, including 3D convolutional encoders, zoom controllers, latent diffusion engines, generative AI models, 3D convolutional decoders, and correlation networks. This subsystem maintains the essential Lorentzian geometry and tensor structure throughout video processing while enabling continuous multi-dimensional zooming across spatial, temporal, and semantic scales.

The supervision pathways connect PCM's cognitive components to the Lorentzian Visual Cortex. Role adaptation manager 115 provides zoom behavior control by analyzing the relative expertise distribution between human and AI participants and selecting appropriate collaborative modes including teacher, student, peer, and assistant configurations. Each mode induces specific zoom strategies: teacher mode emphasizes structured, pedagogical zoom sequences that guide attention from foundational concepts to detailed analysis; student mode enables exploratory zoom patterns that follow human reasoning and attention cues; peer mode supports balanced, parallel zoom operations for collaborative analysis; and assistant mode optimizes for rapid, task-focused zoom operations with minimal cognitive overhead.

Goal manager 120 contributes focus, direction control by synthesizing explicit user objectives with implicit collaborative goals derived from the current interaction context. This component generates goal potential fields that attract zoom operations toward semantically relevant regions while maintaining coordination between human intentions and AI analytical capabilities. The goal-driven focus ensures that zoom operations serve not merely visual magnification purposes, but support meaningful cognitive objectives, including hypothesis testing, anomaly investigation, narrative exploration, and collaborative decision-making.

Collaborative Dynamics Engine (CDE) 130 provides geometric supervision of the Lorentzian autoencoder operations by managing the evolution of the latent manifold structure, computing geodesic paths for zoom trajectories, and applying compression pressure to optimize representational efficiency. The CDE maintains bidirectional communication with latent manifold 160, enabling both the reading of current manifold state and the active modification of geometric properties based on collaborative requirements. This geometric supervision ensures that zoom operations follow mathematically principled paths through the latent space while respecting both human cognitive constraints and AI computational capabilities.

Latent manifold 160 serves as the central integration point where visual thoughts, cognitive structures, and Lorentzian geometry intersect. The manifold maintains Lorentzian geometry with time-like directions that preserve causal structure, thought bundles that represent persistent visual memories and collaborative patterns, geodesic paths that enable optimal traversal through the visual semantic space, and compression pressure fields that guide attention toward regions of high information density or collaborative significance. Visual cognitive structures within the manifold enable seamless integration between symbolic reasoning processes and geometric video operations.

The Lorentzian Visual Cortex subsystem 1800 processes video through its integrated architecture while maintaining continuous communication with the latent manifold. The system produces enhanced visual output 1870 with adaptive zoom capabilities that reflect not only the technical processing of video data, but the integration of collaborative context, expertise assessment, and goal-directed attention. This output enables users to experience video not as static media, but as navigable cognitive terrain where zoom and focus operations serve collaborative intelligence objectives.

Human pattern cache 175 and persistent memory manager 170 provide learning and adaptation capabilities by storing successful zoom interaction patterns, collaborative strategies, and human cognitive preferences. The human pattern cache implements privacy-preserving storage of individual user models while enabling cross-user generalization of effective collaboration strategies. This learning architecture ensures that the system continuously improves its supervision of Lorentzian operations based on accumulated experience with human-AI collaborative video analysis.

The architecture demonstrates how cognitive supervision transforms basic video processing into intelligent, adaptive, collaborative visual analysis. Rather than merely applying fixed zoom algorithms, the system dynamically configures its geometric operations based on real-time assessment of collaborative context, enabling video analysis that adapts to user expertise, responds to collaborative objectives, and learns from interaction patterns. This integration of PCM cognitive architecture with Lorentzian video processing creates a new class of intelligent visual systems capable of supporting sophisticated human-AI collaboration in video analysis applications ranging from surveillance and medical imaging to educational content and creative media production.

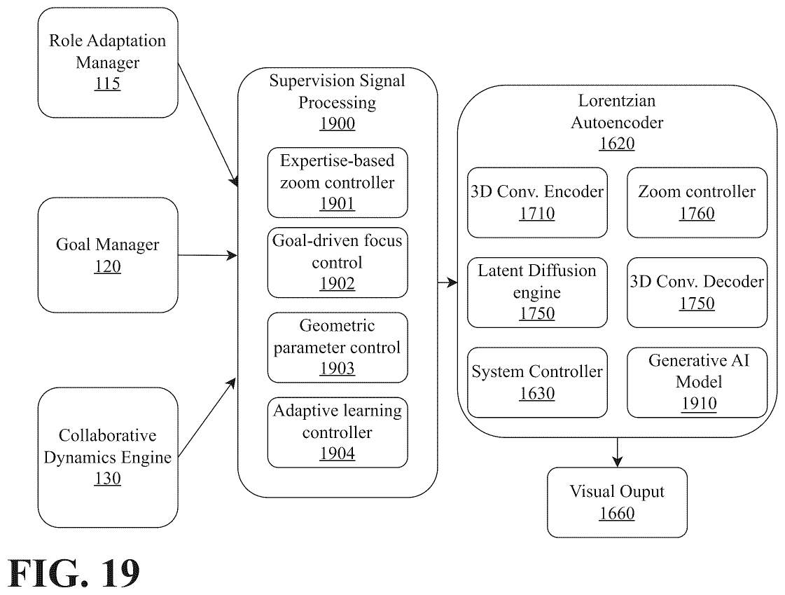

FIG. 19 is a block diagram illustrating an exemplary supervision and control architecture that enables Persistent Cognitive Machine components to dynamically manage and optimize Lorentzian autoencoder operations through real-time parameter adaptation and intelligent control signal processing. This architecture represents the technical implementation of cognitive supervision, demonstrating how high-level collaborative intelligence assessments translate into specific mathematical control parameters that govern geometric operations, zoom behavior, and focus selection within the Lorentzian visual processing subsystem.

Role adaptation manager 115 generates multiple categories of supervision outputs that directly influence autoencoder behavior based on real-time expertise detection and collaborative context analysis. The component produces expertise level assessments that quantify the relative knowledge distribution between human and AI participants across different semantic domains, enabling dynamic adaptation of processing complexity and explanation depth. Role mode specifications determine the current collaborative configuration including teacher, student, peer, and assistant modes, with each mode inducing specific geometric transformations and attention patterns. Zoom policy parameters define the behavioral characteristics for zoom operations appropriate to the detected collaborative context, including exploration versus focused analysis patterns, pedagogical zoom sequences for knowledge transfer scenarios, and rapid task-oriented zoom for assistant mode operations. Coupling strength parameters α control the degree of synchronization between human and AI cognitive processes, computed using functions such as α=tanh(λφ(x)) where λ controls transition sharpness and φ(x) represents the expertise gradient field at point x in the latent manifold.

Goal manager 120 contributes focus direction and attention control through the generation of goal potential fields and priority weighting systems that guide zoom and focus operations toward semantically relevant and task-aligned regions. Focus regions are dynamically identified based on the synthesis of explicit user objectives with implicit collaborative goals derived from interaction history and context analysis. Goal potential field parameters Φ create scalar fields over the latent manifold that attract attention and processing resources toward high-value regions, with field strength and gradient characteristics adapted to the current collaborative mode and task requirements. Priority weights enable differential allocation of computational resources and attention across multiple competing objectives or regions of interest. Attention maps provide spatial guidance for zoom controller operations, indicating not only where to focus but also the appropriate level of detail and processing intensity for different regions based on collaborative objectives and detected user intent.

Collaborative Dynamics Engine 130 provides geometric supervision through the generation and continuous updating of fundamental manifold parameters that govern the mathematical structure within which all visual cognitive operations occur. Metric tensor components g_ij(z,t) define the local distance relationships and geometric properties at each point in the latent hyperspace, with dynamic evolution based on usage patterns, compression requirements, and collaborative effectiveness metrics. Curvature parameters R control the local and global geometric properties that determine how cognitive trajectories bend, converge, or diverge, with positive curvature values encouraging convergence for collaborative alignment and negative curvature enabling exploration and differentiation. Geodesic path specifications provide optimal trajectory calculations for attention movement, memory traversal, and zoom operations, computed using variational methods that minimize collaborative action functionals incorporating both individual cognitive costs and coordination requirements. Compression pressure values P(z) indicate local information density and guide attention allocation, resource prioritization, and structural reorganization during both active processing and offline dreaming phases.

The supervision signal processing layer 1900 transforms these PCM outputs into actionable control parameters through four specialized processing modules that bridge cognitive assessments with mathematical autoencoder operations. Expertise-based zoom control 1901 processes role and expertise information to determine appropriate curvature modulation parameters, with teacher mode implementing increased curvature values between 0.3 and 0.5 on the Ricci scalar to create compression pressure that guides cognitive flow along structured instructional paths, while student mode utilizes flattened curvature approaching 0.05 to enable open exploration following human reasoning patterns without predetermined constraints. Goal-driven focus control 1902 transforms goal potential fields and attention maps into attention flow gradients using computations such as ∇Φ→attention flow, where the gradient of the goal potential field directly influences the direction and magnitude of attentional resources and zoom operations. Geometric parameter control 1903 manages the real-time adaptation of manifold properties including metric tensor evolution, connection coefficient updates, and topology modifications that optimize the latent space structure for current collaborative requirements. The adaptive learning controller 1904 processes feedback from performance monitoring systems and human pattern cache to continuously refine control algorithms, parameter ranges, and adaptation strategies based on accumulated effectiveness metrics and user interaction patterns.

The Lorentzian autoencoder 1620 components receive these processed control signals at specific control input points that enable precise parameter adjustment during operation. 3D convolutional encoder 1710 receives curvature and coupling parameters that modulate its compression behavior, tensor structure preservation, and spatiotemporal relationship encoding based on the current collaborative context and detected expertise distribution. Zoom controller 1760 accepts multiple control inputs including role mode specifications, goal potential field parameters, curvature values, and compression pressure data that collectively determine zoom behavior, focus selection, magnification policies, and attention allocation strategies. System controller 1630 and generative AI model 1910 receive geometric parameters and goal-driven control signals that influence their contribution to the overall visual processing pipeline, ensuring consistency between different processing stages and maintaining alignment with collaborative objectives. Latent diffusion engine 1750 and 3D convolutional decoder 1730 utilize geometric parameters and compression guidance to optimize their reconstruction and enhancement operations for maximum collaborative utility while maintaining computational efficiency.

Visual output 1660 represents the result of this comprehensive supervision architecture, producing video processing results that reflect not merely technical optimization but intelligent adaptation to collaborative context, user expertise, and task objectives. The output quality, zoom behavior, focus selection, and enhancement characteristics dynamically adapt based on the continuous supervision from PCM cognitive components, creating a system that becomes increasingly effective through accumulated experience with different users, tasks, and collaborative scenarios.

Feedback and learning systems including human pattern cache and performance monitor complete the supervision architecture by providing continuous improvement capabilities that refine control algorithms based on effectiveness metrics and user interaction patterns. The human pattern cache stores successful supervision strategies, zoom behaviors, and collaborative patterns while maintaining privacy protections through geometric abstraction and differential privacy transformations. Performance monitoring tracks the effectiveness of different supervision strategies across various collaborative contexts, enabling the system to learn optimal parameter ranges, control timing, and adaptation strategies. These feedback loops ensure that the supervision architecture continuously evolves to provide increasingly precise and effective control of Lorentzian autoencoder operations, creating a system that adapts not only to immediate collaborative requirements but also learns from accumulated experience to anticipate and optimize for future collaborative scenarios.

This supervision and control architecture demonstrates how cognitive intelligence can be operationally integrated with advanced video processing technology, creating systems that provide not just technical capability but intelligent, adaptive, context-aware visual processing that serves collaborative objectives and adapts to human cognitive characteristics and expertise levels.

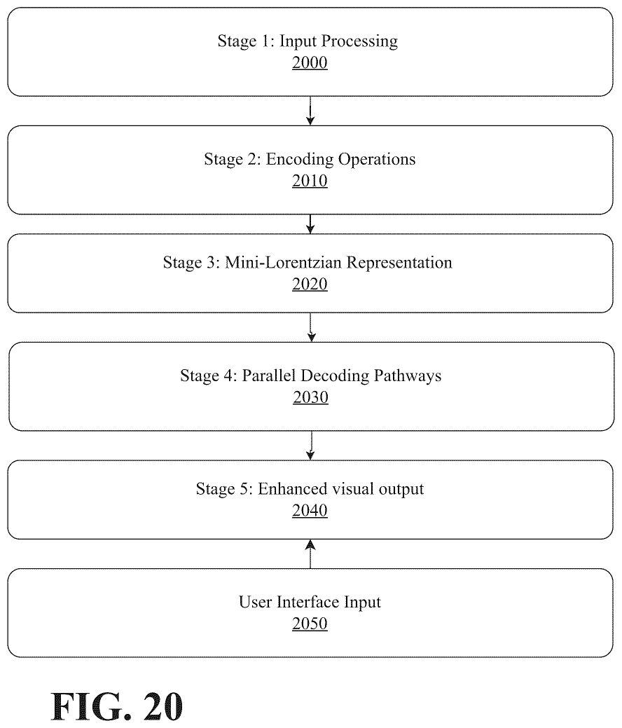

FIG. 20 is a flow diagram illustrating a comprehensive processing architecture of the Lorentzian Visual Cortex subsystem, demonstrating the sequential and parallel pathways that enable adaptive zoom and focus operations through systematic preservation of three-dimensional tensor structures and Lorentzian geometric properties throughout all video processing stages. This visual representation captures the fundamental departure from conventional video processing systems by clearly showing how mathematical coherence of spatiotemporal relationships is maintained while enabling continuous multi-dimensional traversal across spatial, temporal, and semantic scales under intelligent supervision from PCM cognitive components.

The processing pipeline visualization operates through five distinct stages that collectively transform raw video input into enhanced visual output with adaptive zoom capabilities, with each stage clearly delineated and interconnected through directed flow paths that preserve processing causality and data integrity.

The diagram begins with stage 1: input processing 2000, represented as the foundational entry point where video input stream flows into the video frame extractor, which segments incoming video sequences into structured three-dimensional tensors. The visual representation clearly shows how spatial dimensions correspond to frame height and width, temporal dimension represents frame sequence progression, and the tensor structure preserves essential spatiotemporal relationships required for causal processing and geometric operations. The frame extractor implementation, as shown in the flow, incorporates specialized algorithms for maintaining temporal coherence, handling variable frame rates, and organizing pixel data into tensor formats optimized for subsequent Lorentzian geometric processing. The unidirectional flow arrow from this stage establishes the causal progression that characterizes the entire processing pipeline.

The encoding operations at stage 2 2010 is a critical transformation hub where structured tensor data undergoes compression through the 3D convolutional encoder, which applies three-dimensional convolutional operations that simultaneously process spatial and temporal dimensions while preserving essential geometric structure required for zoom operations. The diagram clearly illustrates how the encoder receives PCM control signals, including curvature parameters σ that determine the degree of compression and geometric distortion applied during encoding, with teacher mode configurations implementing higher curvature values to create structured compression paths while student mode configurations utilize flattened curvature to preserve exploration flexibility.

The coupling strength parameters α controlling the degree of synchronization between human attention patterns and AI processing pathways, enabling adaptive processing that responds to collaborative context and detected expertise distributions. The 3D encoder produces compressed tensor representations that maintain the mathematical properties necessary for subsequent geometric operations while achieving significant data reduction through exploitation of spatiotemporal redundancies and collaborative context optimization, as indicated by the controlled flow progression to the next stage.

The mini-Lorentzian representation stage 3 2020 may be the central processing hub in the flow diagram, where compressed video data exists in a mathematically structured form that preserves Lorentzian geometric properties essential for causal relationships and continuous zoom operations. The visual representation demonstrates how this representation maintains tensor structure throughout compression, enabling operations that respect both spatial relationships within frames and temporal causality between frames. The mini-Lorentzian format supports geodesic traversal operations where zoom and focus changes correspond to mathematically principled movement through the latent space rather than arbitrary magnification or cropping operations. There are two critical control pathways that branch from the central hub: the zoom controller, which receives PCM control signals including role mode specifications that determine appropriate zoom behaviors for different collaborative contexts, goal potential field parameters Φ that guide attention toward semantically relevant regions, and compression pressure values P(z) that indicate information density and processing priorities. The system controller coordinates overall processing flow and resource management based on PCM supervision signals, ensuring optimal performance and collaborative alignment across all processing stages.

Stage 4 represents the parallel decoding pathways 2030 which may include four specialized processing components operating simultaneously on the mini-Lorentzian representation. The latent diffusion engine analyzes the mini-Lorentzian representation to model temporal dynamics and predict missing or degraded information based on learned spatiotemporal patterns, enabling reconstruction of details that may have been lost during compression or that exist beyond the resolution limits of original video content, as shown by its dedicated processing pathway. The generative AI model synthesizes additional visual details for regions beyond original video resolution, creating contextually appropriate content that maintains visual consistency with existing video while providing enhanced detail for zoom operations that exceed source material resolution. The flow diagram illustrates how the generative model operates under constraints derived from the Lorentzian geometric structure, ensuring that synthesized content maintains causal consistency and geometric coherence with the original video sequence. The 3D convolutional decoder reconstructs video sequences from the mini-Lorentzian representation through inverse convolutional operations that restore spatial and temporal dimensions while incorporating enhancements from the latent diffusion engine and maintaining geometric properties established during encoding, as depicted by its parallel processing pathway. The correlation network leverages spatiotemporal patterns identified across multiple video segments to restore information potentially lost during compression, using learned correlations between different video regions and time periods to enhance reconstruction quality beyond what would be achievable through independent frame processing. This shows cross-modal enhancement communication pathways (represented by dashed lines) enabling each component to benefit from processing results generated by other components, creating a collaborative processing environment that maximizes enhancement capabilities.

Stage 5: Enhanced visual output 2040 combines results from all processing pathways into cohesive video sequences with adaptive zoom capabilities. The output integration process maintains temporal consistency across video frames during continuous zoom operations, ensures visual coherence between original content and generated details, and preserves the causal relationships encoded in the Lorentzian geometric structure. The enhanced output demonstrates capabilities including continuous spatial zoom beyond original resolution limits, temporal zoom enabling slow-motion or fast-forward operations with interpolated content, semantic zoom that can focus on specific objects or regions within complex scenes, and collaborative zoom that adapts to human attention patterns and expertise levels detected by PCM supervision systems.

This flow diagram illustrates how PCM Control Signals Integration operates throughout the processing pipeline at specific control points that enable real-time adaptation of processing parameters based on collaborative context assessment. The visual representation shows how the 3D convolutional encoder receives curvature and coupling parameters that modulate compression behavior and geometric structure preservation based on detected expertise distributions and collaborative objectives. The Zoom Controller accepts multiple control inputs including role specifications that determine zoom behavior patterns appropriate for teacher, student, peer, or assistant collaborative modes, goal potential parameters that direct attention toward task-relevant regions, and compression pressure indicators that guide resource allocation and detail enhancement priorities.

Lastly, the user interface input 2050 may be an external control pathway that enables real-time interaction with the processing system, allowing users to specify regions of interest and desired magnification levels that directly influence the zoom controller operations and overall processing behavior.

The visual architecture representation enables understanding of not merely technical video processing capabilities, but intelligent, adaptive, context-aware visual processing that serves collaborative objectives while maintaining mathematical rigor and geometric consistency throughout all processing stages. The flow diagram clearly shows how this creates a system capable of supporting sophisticated human-AI collaboration in video analysis and exploration applications across diverse domains and use cases, with each processing stage contributing to the overall capability while maintaining strict mathematical and geometric constraints that ensure processing reliability and consistency

This comprehensive flow diagram serves as both a technical specification and operational guide for implementing the Lorentzian Visual Cortex subsystem, providing clear visual guidance for understanding component relationships, data flow patterns, control signal integration, and the sophisticated parallel processing architecture that enables advanced video enhancement and adaptive zoom capabilities under PCM cognitive supervision.

### Exemplary Computing Environment

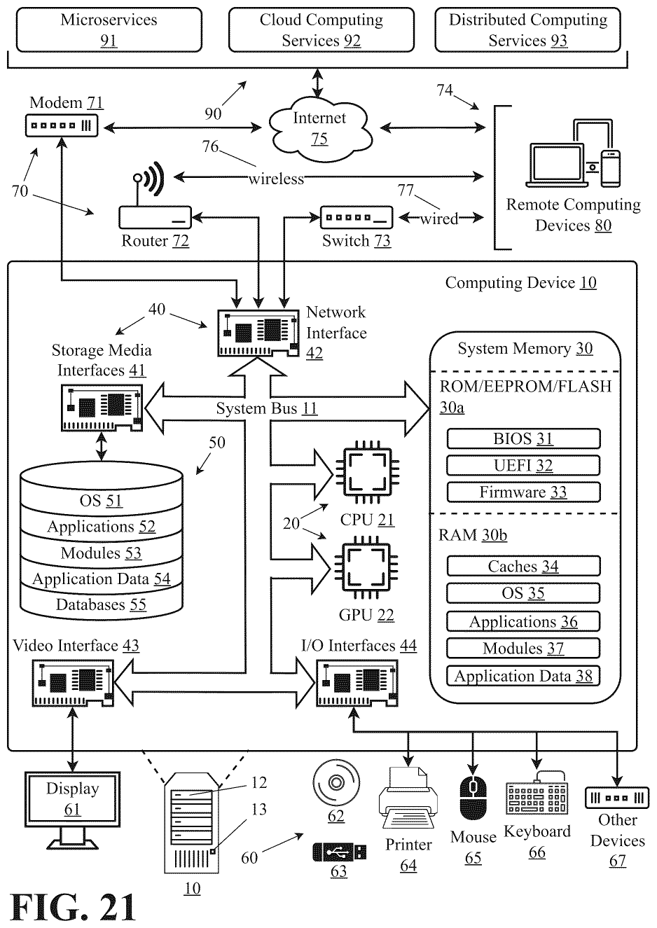

FIG. 21 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ 45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
maintain a latent manifold as a geometric substrate for collaborative cognitive operations and a Lorentzian autoencoder subsystem for video processing operations, wherein the Lorentzian autoencoder preserves spatiotemporal relationships and causal structure through tensor representations;
receive video input and encode video segments into mini-Lorentzian representations through three-dimensional (3D) convolutional encoding that processes spatial and temporal dimensions simultaneously while preserving tensor structure;
provide cognitive supervision of autoencoder operations through a Persistent Cognitive Machine (PCM) that analyzes collaborative context, expertise distribution, and task requirements to generate adaptive control parameters;
generate role-specific zoom behaviors based on detected collaborative modes, wherein teacher mode implements structured pedagogical zoom sequences, student mode enables exploratory zoom patterns following human attention, peer mode supports parallel collaborative analysis, and assistant mode optimizes for rapid task-focused operations;
compute adaptive focus regions through attention fusion that combines human attention patterns with AI priority assessments from saliency analysis and task evaluation;
execute real-time parameter adaptation where PCM supervision signals modify geometric properties of the latent manifold including curvature parameters, coupling strength, and compression pressure fields to optimize zoom and focus operations;
implement hierarchical processing with multiple scale levels that provide scene-wide analysis, intermediate detail processing, and fine-grained inspection capabilities;
decode visual output from the mini-Lorentzian representations through 3D convolutional decoding augmented by latent diffusion and generative AI models for infinite zoom capabilities;
and enable continuous learning through storage of successful zoom interaction patterns and collaborative strategies in privacy-preserving distributed caches that adapt system behavior based on accumulated human-AI interaction experience.

2. The computer system of claim 1, wherein the cognitive supervision comprises role adaptation management that computes expertise gradients across semantic domains and generates curvature modulation parameters with increased values for teacher mode configurations and reduced values for student mode configurations.

3. The computer system of claim 1, wherein the collaborative attention fusion implements weighted integration of human attention patterns, AI priority assessments, and collaborative coordination factors with role-based parameter adjustment.

4. The computer system of claim 1, wherein the multi-scale focus hierarchy implements information-theoretic scale selection that maximizes information preservation while optimizing computational efficiency through content-adaptive scale determination.

5. The computer system of claim 1, wherein the mini-Lorentzian representations maintain three-dimensional tensor structure throughout compression and enhancement operations while supporting traversal for mathematically principled zoom operations across spatial, temporal, and semantic dimensions.

6. The computer system of claim 5, wherein the real-time parameter adaptation minimizes a collaborative action functional that accounts for attention movement costs, compression pressure effects, goal attraction forces, and human-AI synchronization requirements.

7. The computer system of claim 1, wherein the zoom controller receives control inputs comprising role mode specifications, goal potential field parameters, curvature values, and compression pressure data to generate adaptive zoom policies based on expertise distribution, goal fields, geometric parameters, and temporal context.

8. The computer system of claim 1, wherein the software instructions further implement cognitive load management through attention resource allocation with role-specific region limits and threshold monitoring to prevent attention fragmentation.

9. The computer system of claim 1, wherein the latent diffusion engine analyzes mini-Lorentzian representations to model temporal dynamics and predict details for regions beyond original video resolution while maintaining causal consistency with tensor structure constraints.

10. The computer system of claim 1, wherein the distributed cache system implements geometric abstraction and anonymity thresholds to store human zoom interaction patterns while preserving collaborative utility through privacy-preserving transformations that enable cross-user pattern generalization without individual identification.

11. A computer-implemented method for PCM-supervised adaptive zoom and focus in view processing, the method comprising:
maintaining a latent manifold as a geometric substrate for collaborative cognitive operations and operating a Lorentzian autoencoder subsystem for video processing operations, wherein the Lorentzian autoencoder preserves spatiotemporal relationships and causal structure through tensor representations;
receiving video input and encoding video segments into mini-Lorentzian representations through 3D convolutional encoding that processes spatial and temporal dimensions simultaneously while preserving tensor structure;
providing cognitive supervision of autoencoder operations through a Persistent Cognitive Machine (PCM) that analyzes collaborative context, expertise distribution, and task requirements to generate adaptive control parameters;
generating role-specific zoom behaviors based on detected collaborative modes, wherein teacher mode implements structured pedagogical zoom sequences, student mode enables exploratory zoom patterns following human attention, peer mode supports parallel collaborative analysis, and assistant mode optimizes for rapid task-focused operations;
computing adaptive focus regions through attention fusion that combines human attention patterns with AI priority assessments from saliency analysis and task evaluation;
executing real-time parameter adaptation where PCM supervision signals modify geometric properties of the latent manifold including curvature parameters, coupling strength, and compression pressure fields to optimize zoom and focus operations;
implementing hierarchical processing with multiple scale levels that provide scene-wide analysis, intermediate detail processing, and fine-grained inspection capabilities;
decoding enhanced visual output from the mini-Lorentzian representations through 3D convolutional decoding augmented by latent diffusion and generative AI models for infinite zoom capabilities; and
enabling continuous learning through storage of successful zoom interaction patterns and collaborative strategies in privacy-preserving distributed caches that adapt system behavior based on accumulated human-AI interaction experience.

12. The method of claim 11, wherein providing cognitive supervision comprises computing expertise gradients across semantic domains and generating curvature modulation parameters with increased values for teacher mode configurations and reduced values for student mode configurations.

13. The method of claim 11, wherein computing adaptive focus regions comprises implementing weighted integration of human attention patterns, AI priority assessments, and collaborative coordination factors with role-based parameter adjustment.

14. The method of claim 11, wherein implementing hierarchical processing comprises performing scale selection that maximizes information preservation while optimizing computational efficiency through content-adaptive scale determination.

15. The method of claim 11, wherein encoding video segments comprises maintaining a three-dimensional tensor structure throughout compression and enhancement operations while supporting traversal for mathematically principled zoom operations across spatial, temporal, and semantic dimensions.

16. The method of claim 15, wherein executing real-time parameter adaptation comprises minimizing a collaborative action functional that accounts for attention movement costs, compression pressure effects, goal attraction forces, and human-AI synchronization requirements.

17. The method of claim 11, wherein generating role-specific zoom behaviors comprises receiving control inputs comprising role mode specifications, goal potential field parameters, curvature values, and compression pressure data to generate adaptive zoom policies based on expertise distribution, goal fields, geometric parameters, and temporal context.

18. The method of claim 11, further comprising implementing cognitive load management through attention resource allocation with role-specific region limits and threshold monitoring to prevent attention fragmentation.

19. The method of claim 11, wherein decoding enhanced visual output comprises analyzing mini-Lorentzian representations to model temporal dynamics and predict enhanced details for regions beyond original video resolution while maintaining causal consistency with tensor structure constraints.

20. The method of claim 11, wherein enabling continuous learning comprises implementing geometric abstraction and anonymity thresholds to store human zoom interaction patterns while preserving collaborative utility through privacy-preserving transformations that enable cross-user pattern generalization without individual identification.
